(19) United States
(12) Patent Application Publication
(10) Pub. No.: US 2016/0325976 A1
(43) Pub. Date: Nov. 10, 2016

(54) Beverage Dispensing Module and Flexible Pouch

(71) Applicant: PERNOD RICARD SA, Paris (FR)

(72) Inventors: Ian Allan Guy, Paris (FR); Sarah Helen Liddell, Paris (FR); Steven John Kelly, Paris (FR); James Ashley Gadd, Paris (FR); Tom Foran, Paris (FR); Stephen Phillip De Saules, Paris (FR)

(21) Appl. No.: 15/108,514

(22) PCT Filed: Dec. 23, 2014
(86) PCT No.: PCT/EP2014/079237

§ 371 Date: Jun. 27, 2016

(30) Foreign Application Priority Data
Dec. 30, 2013 (GB) 1323126.1
Jun. 23, 2014 (GB) 1411147.0
Nov. 3, 2014 (GB) 1419587.9
Nov. 3, 2014 (GB) 1419589.5

(51) Int. Cl. B67D 1/00; B67D 1/12; B67D 1/08

(52) U.S. Cl. CPC B67D 1/0001; B67D 1/0801; B67D 1/1281; B67D 2001/0827

(57) ABSTRACT

This invention is directed toward a beverage dispensing module and flexible pouch. The beverage dispensing module is suitable for alcoholic beverages. The beverage dispensing module includes an outlet arrangement for selectively dispensing beverage, a pressurizing arrangement including resilient bias means connected to a roller and a beverage pouch fluidly connected to the outlet arrangement and mounted with the roller. The resilient bias means, outlet arrangement and roller are configured to form an overpressure, relative to atmospheric pressure, within the pouch.

### TECHNICAL FIELD

This invention is directed towards a beverage dispensing module and flexible pouch for such a beverage dispensing module. The beverage dispensing module is particularly suitable for alcoholic beverages.

### BACKGROUND

Beverages, for example alcoholic beverages, sodas, concentrates and the like, are commonly supplied individually to consumers in bottles and typically glass bottles. However, glass bottles utilise space inefficiently when stacked, are relatively heavy and can be broken relatively easily when subjected to an impact. Therefore, they are not optimally suited to transportation. Furthermore, when a bottle is opened air is able to contact the beverage, which may result in the evaporation of the beverage and/or causing the beverage to degrade. For example, the alcohol in an alcoholic beverage will evaporate, thereby reducing the alcoholic content of the beverage. The air may also oxidise the alcohol such that the taste of the beverage changes.

Bag-in-box type containers commonly prevent air from contacting the beverage by comprising a one-way valve which allows beverage to flow out of, but prevents air from flowing into, the bag. However, such bag-in-box containers are not considered to be premium products by consumers and have, as a result, not replaced glass bottles as the typical beverage container. The bag-in-box type containers are also commonly very large (e.g. 3 to 5 litres) and are not suited to storing beverages, such as liquors, which are commonly supplied only in relatively smaller quantities (e.g. 1 litre). The box is also typically formed of cardboard or the like and thus has a relatively low structural strength. Therefore, they are not suited to vertical stacking in large numbers.

### SUMMARY OF INVENTION

The present invention is directed in one aspect towards a beverage dispensing module comprising: an outlet arrangement for selectively dispensing beverage; a pressurising arrangement comprising resilient bias means connected to a roller; a beverage pouch fluidly connected to the outlet arrangement and mounted with the roller; wherein the resilient bias means, outlet arrangement and roller are configured to form an overpressure, relative to atmospheric pressure, within the pouch.

The present invention is directed in a further aspect towards a beverage dispensing module comprising: a beverage reservoir; a module outlet; and a duckbill valve positioned between the beverage reservoir and the module outlet for selectively enabling fluid communication therebetween, the duckbill valve comprising: first and second valve walls converging from first ends to second ends, the second ends being positioned closer to the reservoir than the first ends, and the second ends defining a valve mouth between valve tips.

The present invention is directed in yet a further aspect to a flexible pouch for a beverage comprising: a first major side panel connected to a first minor side panel along a first corner; a second major side panel connected to the first minor side panel along a second corner; and a first sealed region between the first major and minor side panels, wherein the first sealed region: extends along and is located adjacent to the first corner; and extends orthogonal to the first corner into the first major and minor side panels by a first width, said first width being greater in a central portion along the first corner than on either side of the central portion.

The present invention is directed in yet a further aspect to a flexible pouch for a beverage comprising: a first major side panel connected to a first minor side panel along a first corner; a second major side panel connected to the first minor side panel along a second corner; and a first sealed region between the first major and minor side panels, wherein the first sealed region: extends along and is located adjacent to the first corner; extends orthogonal to the first corner into the first major and minor side panels by a first width; and comprises a first portion extending from a first end of the first major and minor side panels towards a midpoint along the first corner, wherein the first width of the first portion decreases away from the first end.

In a preferred embodiment the container to which the beverage dispensing arrangement is attached comprises a housing and first and second end covers. The housing comprises first and second major and minor side walls and, at either end thereof, forms an opening for receiving the first and second end covers. The first and second end covers comprise at least one protrusion for mounting into recesses formed in, or adjacent to, the inner face of at least one of the side walls. The engagement between the protrusions and recesses holds the end covers in place. In a further embodiment the second minor side wall is formed from two minor side panels of the housing. A tear strip is provided from the first to second end of the outer minor side panel and the two minor side panels are adhered to one another such that when the tear strip is removed the two minor side panels are disconnected. Therefore, the housing can be unwrapped and easily recycled.

The beverage dispensing module is suitable for containing alcoholic beverages and is particularly suitable for containing spirits, such as whisky, vodka, gin, liqueur, coffee liqueur, rum, aniseed-based spirit, pastis, cognac, brandy or tequila. The beverage dispensing module may also be suitable for containing other alcoholic beverages including champagne, wine, beer or cocktails, and/or other types of beverage, including sodas (also known as soft drinks) and beverage concentrates.

### BRIEF DESCRIPTION OF THE DRAWINGS

By way of example only, embodiments of the present invention are now described with reference to, and as show in, the accompanying drawings, in which:

FIG. 1 is a perspective view of an exemplary beverage dispensing module of the present invention;

FIG. 2 is a exploded view of a first embodiment of the construction of the beverage dispensing module of the present invention;

FIG. 3 is a perspective view illustrating a step in the assembly of the embodiment of FIG. 2;

FIG. 4 is a perspective view illustrating the embodiment of FIG. 2 when assembled;

FIG. 5 is an exploded perspective view of a second embodiment of the construction of the beverage dispensing module of the present invention;

FIG. 6 is an exploded perspective view of a third embodiment of the construction of the beverage dispensing module of the present invention;

FIG. 7 is an exploded perspective view of a fourth embodiment of the construction of the beverage dispensing module of the present invention;

FIG. 8 is an exploded perspective view of a fifth embodiment of the construction of the beverage dispensing module of the present invention;

FIG. 9A is an exploded perspective view of a sixth embodiment of the construction of the beverage dispensing module of the present invention;

FIG. 9B is a perspective view of a housing of the embodiment of FIG. 9A when assembled;

FIG. 10 is an exploded perspective view of an embodiment of the beverage dispensing module of the present invention including a beverage reservoir and beverage dispensing arrangement;

FIG. 11 is a perspective cross-sectional view of the module of FIG. 10 when assembled and with the beverage reservoir not shown;

FIG. 12 is a side elevation of the module of FIG. 10 when assembled wherein a side wall is not shown to illustrate the arrangement of the beverage reservoir and beverage dispensing arrangement;

FIG. 13 is a front elevation of the module of FIG. 10 wherein the front side wall is not shown;

FIG. 14 is a perspective view of a pouch of the beverage dispensing module of the present invention;

FIG. 15 is a side elevation of the pouch of FIG. 14;

FIG. 16 is a further side elevation of the pouch of FIG. 14;

FIG. 17 is a schematic of a blank for forming the pouch of FIG. 14;

FIG. 18 is a schematic of a blank for forming a further embodiment of a pouch of the beverage dispensing module of the present invention;

FIG. 19 is a side elevation of a second end of an embodiment of a pouch of the present invention including attachment means;

FIG. 20 is a partially hidden perspective view of a further embodiment of the pouch of the present invention illustrating a gusset provided inside the pouch;

FIG. 21A is a perspective view of an outlet arrangement of the module of FIG. 10;

FIG. 21B is an enlarged view of FIG. 11 illustrating the components of the outlet arrangement in further detail;

FIGS. 22A and 22B are a cross-sectional side elevation and perspective view of a valve arrangement of the module of FIG. 10; and

FIGS. 23A and 23B are schematics of embodiments of a pressuring arrangement of the present invention comprising elastic members mounted to a roller.

### DETAILED DESCRIPTION

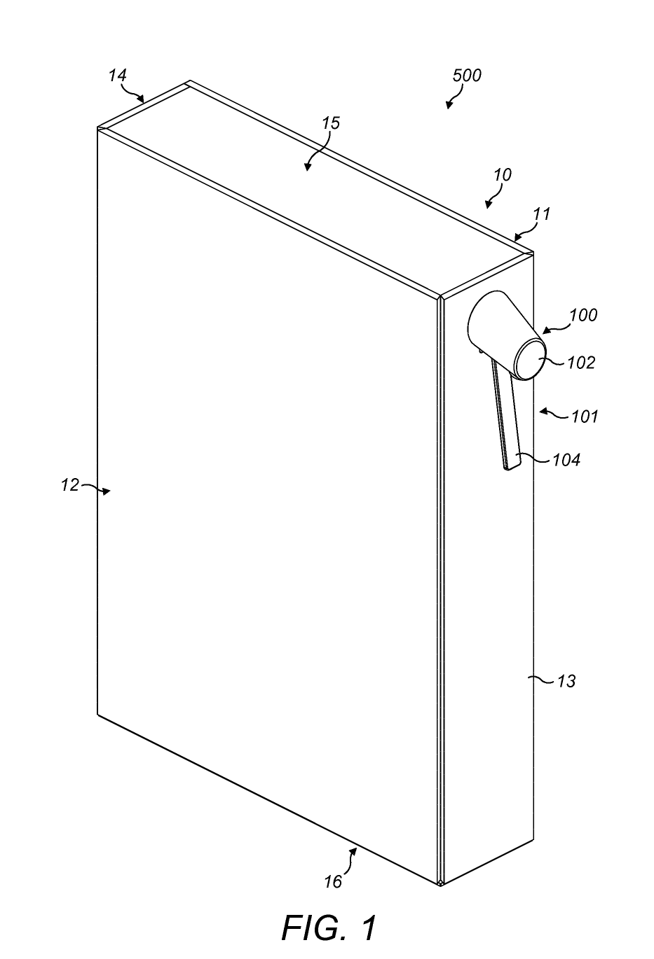

FIG. 1 illustrates an embodiment of the present invention in which a beverage dispensing module 500 is operable to stand on a surface independently and is generally bibliomorphic (book shaped). The module 500 comprises a container 10 having first and second major side walls 11, 12, first and second minor side walls 13, 14 and first and second end walls 15, 16. In the present disclosure the term “minor” is used to indicate a small dimension (e.g. area or length) and the term “major” is used to indicate a larger dimension. For example, the surface area of each of the first and second major side walls 11, 12 is larger than the surface area of each of the first and second minor side walls 13, 14.

As illustrated in FIG. 1 the walls are each substantially rectangular in shape. Each major edge of the first and second major side walls 11, 12 is coincident with a major edge of the first or second minor side wall 13, 14. Each minor edge of the first and second major side walls 11, 12 is coincident with a major edge of the first and second end walls 15, 16. Each minor edge of the first and second minor side walls 13, 14 is coincident with a minor edge of the first and second end walls 15, 16. The container 10 therefore has a substantially rectangular cuboidal shape and is, in a particularly preferred arrangement, of a height, width and depth such as to provide an upright container which is both capable of being freestanding and is also relatively stable in that configuration. In alternative embodiments the container 10 has another suitable shape, such as a cube or square cuboid.

The beverage dispensing module 500 further comprises a beverage dispensing arrangement 100. The beverage dispensing arrangement 100 comprises an outlet arrangement 101 for controlling liquid beverage flow or selectively dispensing liquid beverage from a beverage reservoir located within the container 10. The outlet arrangement 101 comprises an outlet nozzle 102 mounted to the outside of the container 10 and a beverage dispensing valve 103 located at least partially within the container 10. The beverage dispensing valve 103 is controlled by a dispensing actuator 104. The beverage dispensing arrangement 100 is discussed in more detail below.

### Container Construction

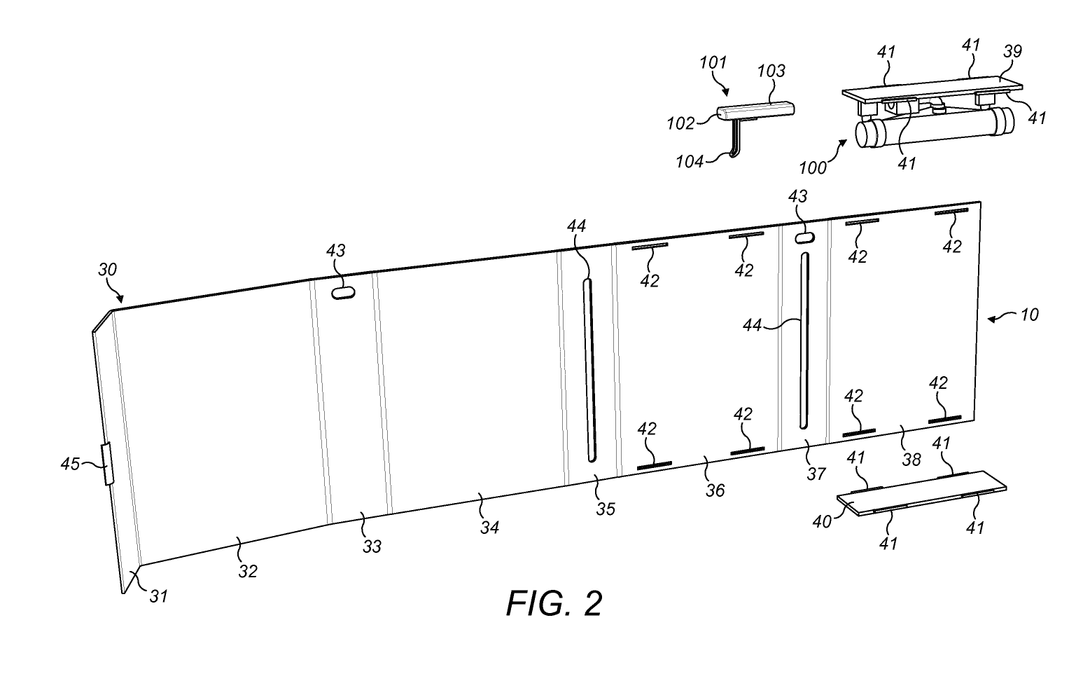

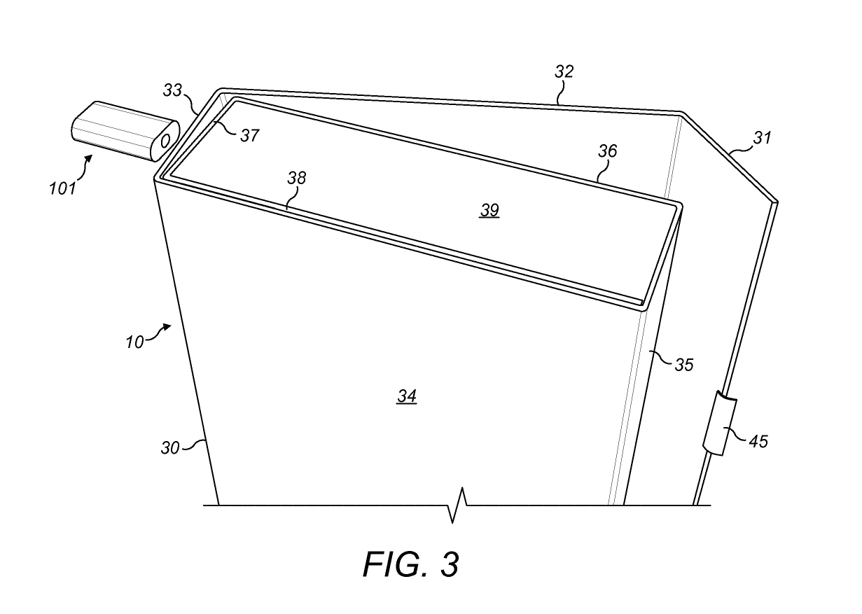

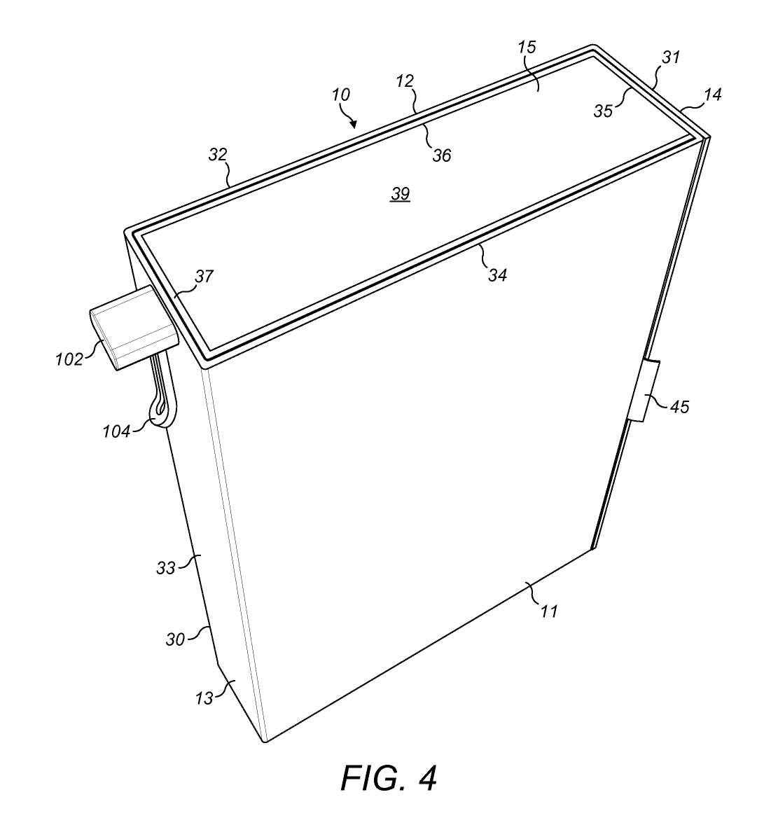

The container 10 may be constructed in any suitable manner and several embodiments of the construction are illustrated in FIGS. 2 to 8.

In the first embodiment, as illustrated in FIGS. 2 to 4, the container 10 comprises a housing 30 forming the first and second minor and major side walls 11, 12, 13, 14. The housing 30 comprises substantially rectangular first, second, third and fourth minor and major housing panels 31, 32, 33, 34, 35, 36, 37, 38, top panel 39 and bottom panel 40. The first major housing panel 32 is attached along opposing major edges to major edges of the first and second minor housing panels 31, 33. The second major housing panel 34 is attached along opposing major edges to major edges of the second and third minor housing panels 33, 35. The third major housing panel 36 is attached along opposing major edges to major edges of the third and fourth minor housing panels 35, 37. The fourth major housing panel 38 is attached along a major edge to a major edge of the fourth minor housing panel 37. A major edge of each of the first minor housing panel 31 and fourth major housing panel 38 and all of the minor edges of the housing panels 31, 32, 33, 34, 35, 36, 37, 38 are free from other housing panels 31, 32, 33, 34, 35, 36, 37, 38.

Each of the top and bottom panels 39, 40 comprise protrusions 41 around their periphery for mounting into apertures 42 in the housing panels 31, 32, 33, 34, 35, 36, 37, 38. In particular, two protrusions 41 are provided on each major edge of the top and bottom panels 39, 40 and corresponding mounting apertures 42 are provided adjacent the minor edges of the third and fourth major housing panels 36, 38. Apertures 43 are provided towards an upper end of the second and fourth minor housing panels 33, 37 for receiving the outlet arrangement 101. Components of the beverage dispensing arrangement 100 may be attached to the underside of the top panel 39, as will be described below. Slots 44 or the like may be provided along the third and fourth minor housing panels 35, 37 for receiving the ends of a roller of the beverage dispensing arrangement 100, as will also be described below.

During assembly the housing 30 may be folded along fold lines in between each of the housing panels 31, 32, 33, 34, 35, 36, 37, 38 such that the first and second minor housing panels 31, 33 form the second and first side walls 14, 13 respectively of the container 10 and the first and second major housing panels 32, 34 form the first and second major side walls 11, 12 respectively. The third and fourth minor and major housing panels 35, 36, 37, 38 are enclosed therein. The top and bottom panels 39, 40 are mounted adjacent the minor edges of the housing panels 31, 32, 33, 34, 35, 36, 37, 38 in the apertures 42, thereby forming the container 10 as an enclosure. Adhesive or other fixing means may be provided to hold the housing 30 in such an arrangement. A tab 45 may be provided for a user to easily break the adhesive or fixing means such that they can disassemble the housing 30, thereby enabling access to the parts of the container 10 for recycling or the like.

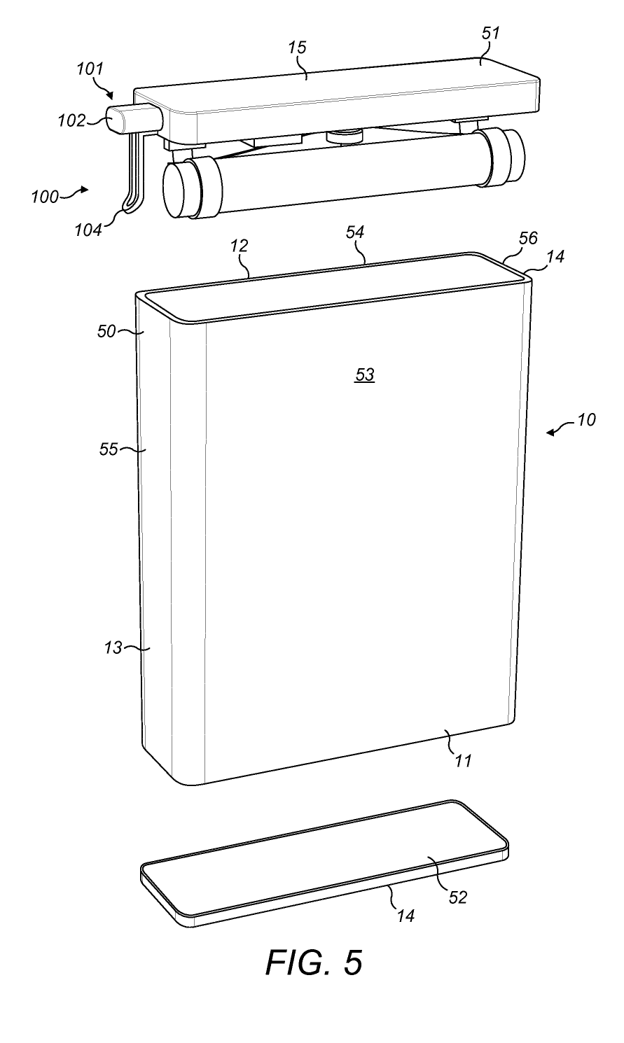

In the second embodiment, as illustrated in FIG. 5, the container 10 comprises a unitary housing 50 and top and bottom panels 51, 52. The housing 50 is formed from a relatively thin-walled tubular structure having a substantially rectangular cross-sectional shape when viewed from the top of the container 10 (i.e. in plan view). Thus the housing 50 forms a substantially rectangular cuboid shape. The housing 50 comprises first and second major housing panels 53, 54 forming first and second major side walls 11, 12 respectively of the container 10 and connected at major edges to first and second minor housing panels 55, 56 forming first and second minor side walls 13, 14 of the container 10. In a similar manner to the first embodiment, components of the beverage dispensing arrangement 100 may be attached to the underside of the top panel 51, which forms the first end wall 15. The bottom panel 52 forms the second end wall 14. Slots (not shown) may be provided down the inside of the first and second minor housing panels 55, 56 for receiving and guiding a roller of the beverage dispensing arrangement 100. An enclosed container 10 is formed by attaching the top and bottom panels 51, 52 to the open ends of the housing 50, for example by adhesive and/or a press fit. In contrast to the first embodiment, the top and bottom panels 51, 52 may protrude from the housing 50 rather than be located inside it when the container 10 is assembled.

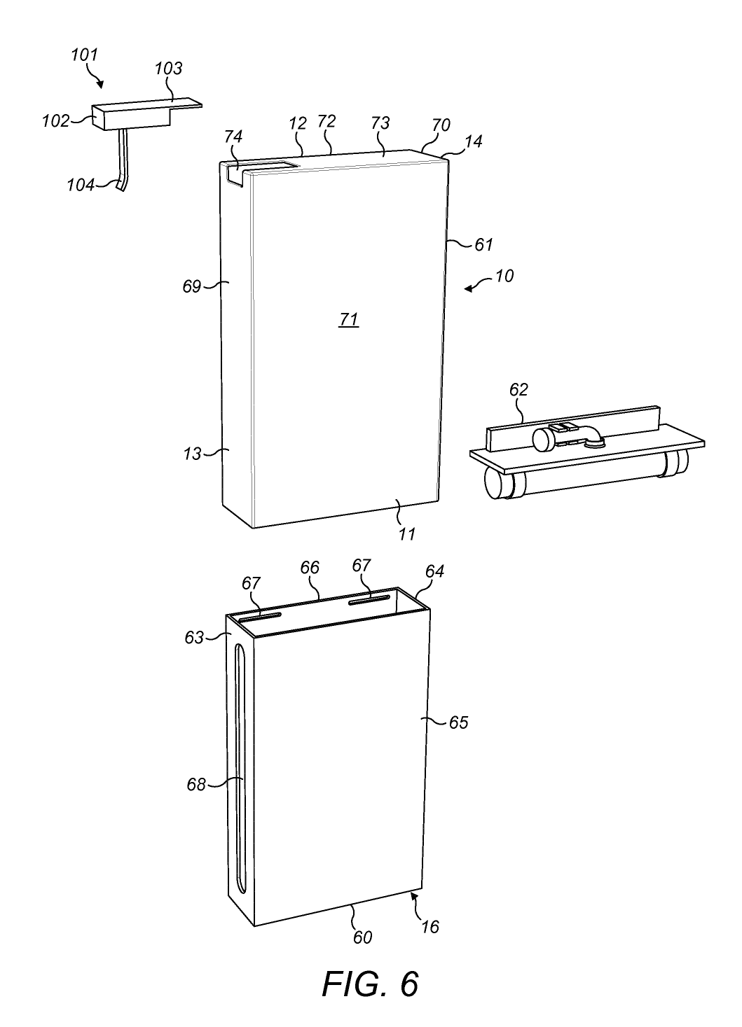

In a third embodiment, as illustrated in FIG. 6, the container 10 may comprise an inner housing 60, an outer housing 61 and a dispensing arrangement mount 62. Each of the inner and outer housings 60, 61 may be of a unitary structure and form a hollow, substantially rectangular cuboid shape. The inner housing 60 may comprise first and second minor inner housing panels 63, 64 connected at major edges to first and second major inner housing panels 65, 66. A bottom panel (not shown) is connected to the bottom minor edges of each of the inner housing panels 63, 64, 65, 66 and forms the second end wall 16 of the assembled container 10. Recesses or apertures 67 are provided in the first and second major inner housing panels 65, 66 for receiving the corresponding protrusions (not illustrated) on the dispensing arrangement mount 62. Slots 68 or the like may be provided along the first and second minor inner housing panels 63, 64 for receiving the ends of a roller of the beverage dispensing arrangement 100, as will also be described below.

The outer housing 61 comprises first and second minor outer housing panels 69, 70, forming first and second minor side walls 13, 14 of the container 10, and connected at major edges to first and second major inner housing panels 71, 72, forming first and second major side walls 11, 12 respectively of the container 10. A top panel 73 is connected to the bottom minor edges of each of the inner housing panels 63, 64, 65, 66 and forms the first end wall 15 of the assembled container 10. An aperture 74 is provided adjacent the top end of the outer housing 61 for receiving the outlet arrangement 101. When assembled, the outer housing 61 fits over the inner housing 60 and is attached thereto by a fixing means, such as an adhesive or the like. The dispensing arrangement mount 62 is mounted within the inner housing 60 and supports the beverage dispensing arrangement 100 therein.

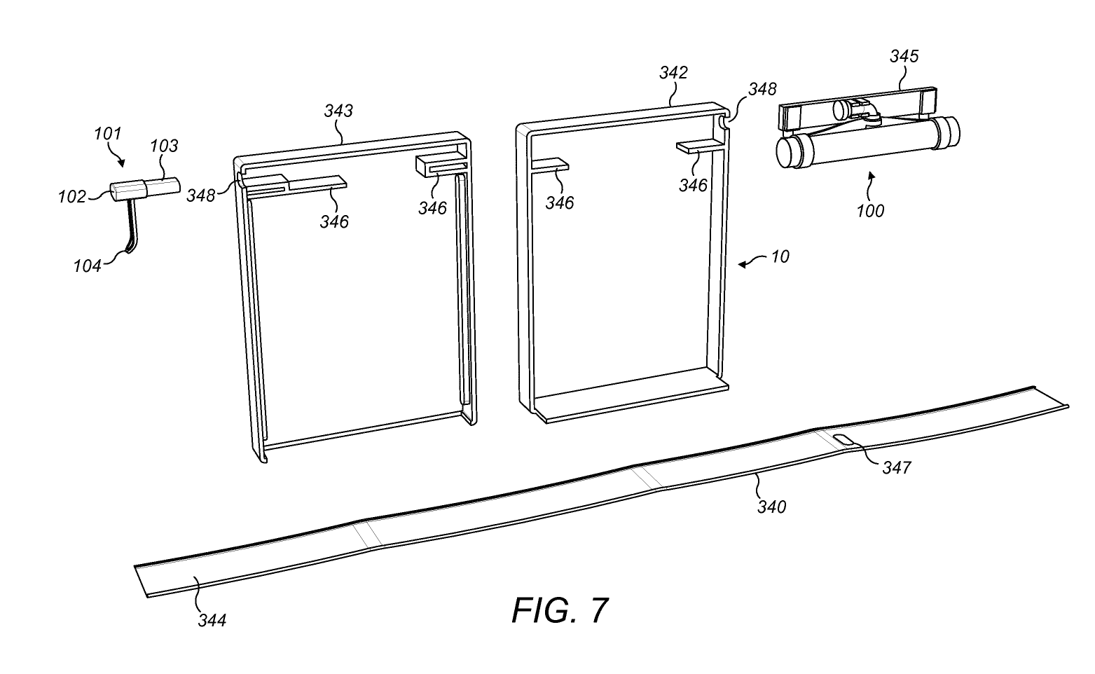

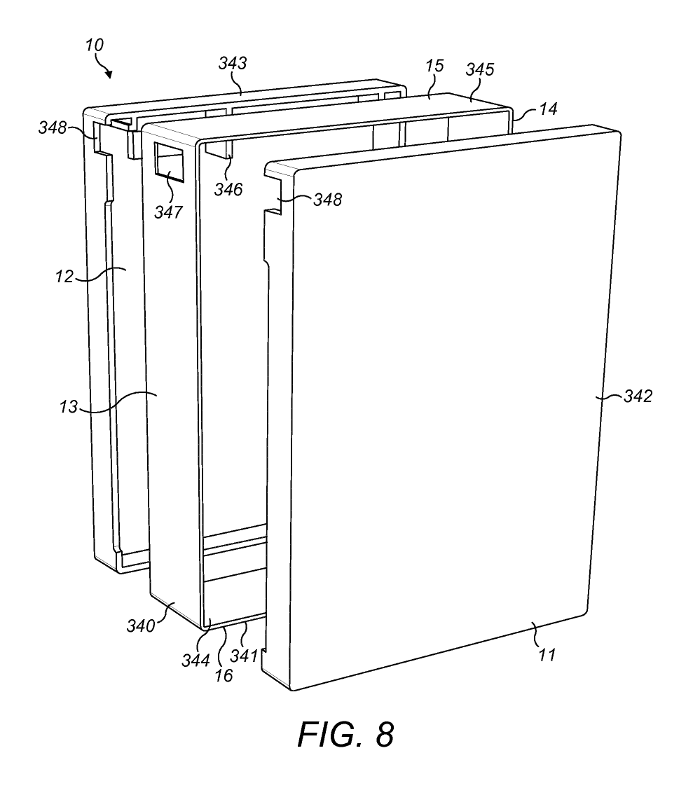

In fourth and fifth embodiments, as illustrated in FIGS. 7 and 8, the container 10 comprises a rigid hoop or band 340 surrounding and defining an opening 341. The band opening 341 is closed laterally (i.e. on either side of the band 340) by first and second walls 342, 343 mounted inside the band 340, thereby forming a substantially sealed enclosure within. The first and second walls each comprise inturned panels for locating within the band 340. The outlet arrangement 101 is mounted to the band 340 and the first and second wall 342, 343. The first and second minor side walls 13, 14 and first and second end walls 15, 16 are formed by the band 340. The first and second major side walls 11, 12 are formed substantially from the outer edges of the band 340 and the first and second walls 342, 343.

The band 340 comprises a strip having major internal and external surfaces 344, 345 formed substantially as a loop. The external surface 344 faces substantially away from the band 340 and the internal surface 345 faces towards itself or inwards from the band 340. The band 340 extends all the way around the periphery of the first and second walls 342, 343. The band 340 may also be described as a loop, ring, brace or hoop comprising a substantially continuous outer surface. The meaning of the term “substantially continuous” includes the embodiments wherein a split (described hereinbelow) is provided in the band.

As illustrated in FIG. 8, the band 340 may be substantially rectangular. The band 340 generally comprises at least one substantially flat outer surface to enable the container 10 to rest in a stable manner on a flat surface. The band 340 provides the primary structural support for the container 10. The band 340 prevents inwards collapse of the container 10 and thereby maintains the shape of the container 10 when a force is applied to the first and second minor side walls 13, 14 and first and second end walls 15, 16. The band 340 is stiffer than the first and second side walls 342, 343.

The band 340 may be manufactured, for example, from a single cast of metal or from moulded plastic. Alternatively the band 340 is manufactured by bending an elongate plate or strip back on itself at four corners and joining the two ends of the plate together, for example by using a welding technique. The band 340 may alternatively be formed from a paper-based material, such as cardboard.

A number of different arrangements may be employed to mount the first and second walls 342, 343 with the band 340, as illustrated in FIGS. 7 and 8.

In the fourth embodiment of FIG. 7, the band 340 is split such that it may be extended in a flat configuration. This permits the width of the band 340 to be increased/expanded, in order to allow the first and second walls 342, 343 more readily to be separated from the band 340. This improves the ease of disassembly of the container 10. Alternatively, the band 340 may be completely continuous with no splits, as in the fifth embodiment of FIG. 8.

The first and second walls 342, 343 each comprise mounting means 346 for receiving and supporting a dispensing arrangement mount 345 to which the beverage dispensing arrangement 100 is attached. Apertures 347, 348 are provided in the hoop 340 and first and second walls 342, 343 for receiving the outlet arrangement 101.

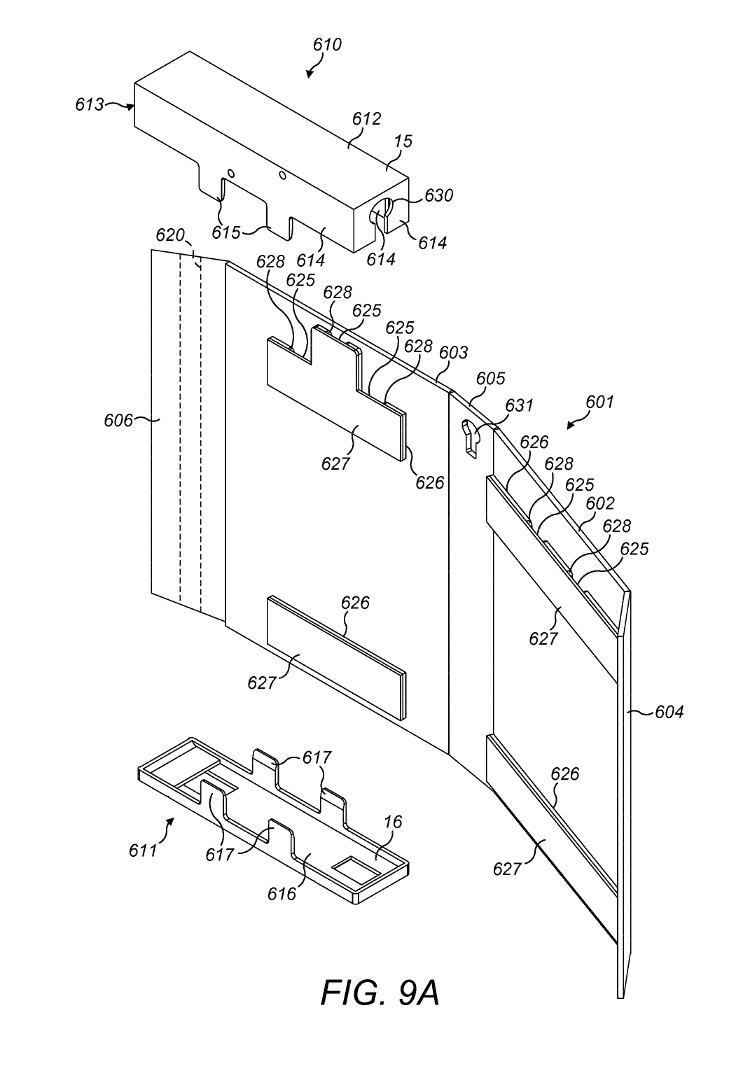

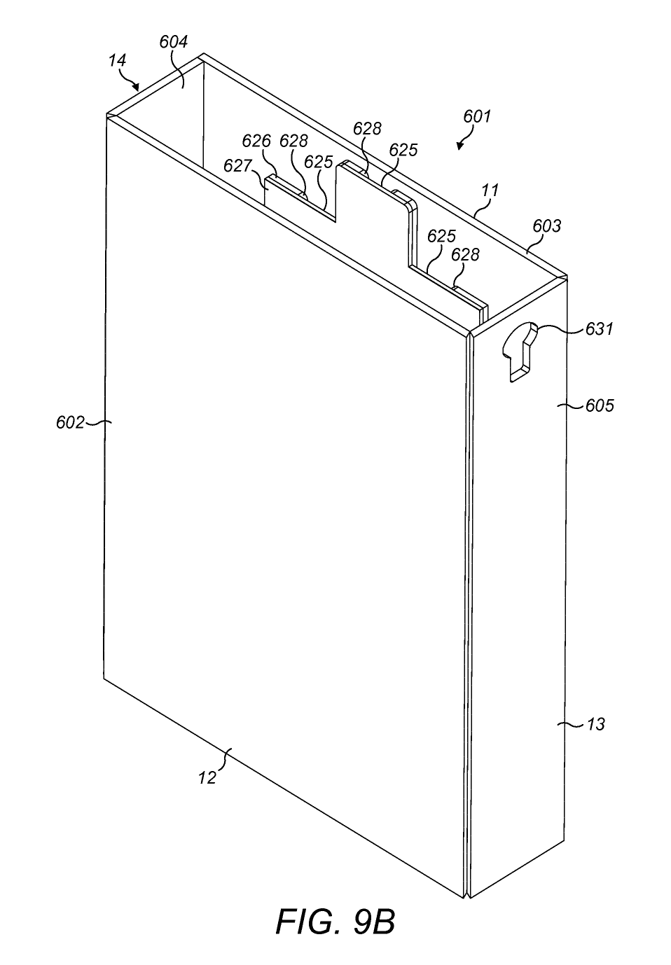

In a sixth, preferred, embodiment, as illustrated in FIGS. 9A and 9B, the the container 10 comprises a housing 601 forming the first and second minor and major side walls 11, 12, 13, 14. The housing 601 is illustrated in an assembled state in FIG. 9B. The housing 601 comprises substantially rectangular first and second major housing panels 602, 603 and first, second and third 604, 605, 606 minor housing panels. A first major edge of the first minor housing panel 604 is attached to a first major edge of the first major housing panel 602 and the opposing second major edge of the first minor housing panel 604 is a free edge. The second major edge of the first major housing panel 602 is attached to a first major edge of the second minor housing panel 605. The second major edge of the second minor housing panel 605 is attached to a first major edge of the second major housing panel 603. The opposing second major edge of the second major housing panel 603 is attached to a first major edge of the third minor housing panel 606. The second major edge of the third minor housing panel 606 is a free edge.

All of the housing panels 602, 603, 604, 605 other than the third minor housing panel 606 are formed of substantially rigid material, such as a stiff card. The third minor housing panel 606 is preferably formed of a relatively flexible material, although it may be formed from the same material as the other panels 602, 603, 604, 605.

The third minor housing panel 606 comprises a tear strip 620 extending therealong between the first and second end walls 15, 16. When the housing 601 is assembled, the third minor housing panel 606 overlies the first minor housing panel 604 such that the first minor housing panel 604 is covered from the outside of the container 10. Between the tear strip 620 and first major edge of the third minor housing panel 606 the third minor housing panel 606 is left unbonded to the first minor housing panel 604. However, the third minor housing panel 606 is bonded to the first minor housing panel 604 between the tear strip 620 and free second major edge of the third minor housing panel 606. Therefore, if the tear strip 620 is torn, the housing 601 is disassembled.

The container 10 further comprises first and second end covers 610, 611. The first end cover 610 comprises a panel 612 attached to a dispensing arrangement mount 613. The dispensing arrangement mount 613 comprises four side walls 614 extending from the periphery of the panel 612. The side walls 614 comprise protrusions 615 extending therefrom. The second end cover 611 comprises a major panel 616 with protrusions 617 extending orthogonal to the plane of the major panel 616 from the periphery of the major panel 616.

Each of the protrusions 615, 617 are arranged to be mounted into internal recesses 625 formed on the inside of the major panels 602, 603 of the housing 601. The mounting of the protrusions 615, 617 and recesses 625 ensures that the end covers 610, 611 remain in place, but also prevents the major housing panels 602, 603 from bulging outwards when placed under force from the beverage reservoir therein. As illustrated in FIG. 9A, the recesses 625 may be formed as slots by multiple layers 626, 627 of panels. The first layer 626, adjacent to the major panels 602, 603, is shaped to comprise at least one indentation 628 and is substantially the same thickness as the protrusions 615, 617. The at least one indentation 628 comprises a shape corresponding to the protrusions 615, 617 such that the protrusions 615, 617 can be inserted therein. The second layer 627 is provided over the first layer 626 and overlies the indentation(s) 628, thereby forming the recesses 625.

The second minor housing panel 605 and a side wall 614 of the dispensing arrangement mount 613 comprise corresponding apertures 630, 631 for receiving the outlet nozzle 102. The apertures 630, 631 are therefore formed substantially adjacent to an end of the container 10.

The container 10 may be shaped and sized to fit through a domestic letterbox (mail slot). In Europe, the opening in such a letterbox is typically around 250 mm wide and around 30-40 mm high, so the dimensions of a cross-section of the container 10 may be less than, say, 250 mm×40 mm. In a particular embodiment, the container 10 has the dimensions of about 200 mm×150 mm×36 mm. Preferably the minor dimension of the first and second minor sides walls 13, 14 and first and second end walls 15, 16 is less than 40 mm, more preferably less than 35 mm and more preferably less than 30 mm. Such dimensions equally permit delivery of the container 10 to a curbside mailbox such as is common in North America.

The material selected to form the container 10 maintains the integrity of the reservoir when the container 10 is dropped through a letterbox onto the floor inside a building or onto the bottom of a mailbox. Again, in Europe, current standards permit the letterbox to be anywhere between 0.7 m and 1.7 m above the ground and the structure and integrity of the container 10 must be sufficient to accommodate this drop. Of course, where a mailbox is provided instead of an opening in a door of a dwelling, for example, the drop to the bottom of the mailbox from its opening is relatively short.

The structural support provided by the cuboidal shape of the container 10 enables a plurality of modules 500 to be stacked adjacent to and/or on top of one another. Stacking efficiency is thereby achieved by the saving of space during stacking.

In the embodiments the walls 11, 12, 13, 14, 15, 16 are preferably formed of a relatively rigid but deformable and lightweight material so as to provide, on the one hand, a degree of rigidity and impact protection to the container 10, but equally to allow manipulation (by hand or machine) so as to facilitate construction and dismantling of the container 10 as described below. It is further desirable that the walls 11, 12, 13, 14, 15, 16 are formed of a material or materials that is/are insoluble in water, and preferably liquid absorbent as well. The purpose of this is to avoid disintegration of the walls 11, 12, 13, 14, 15, 16 should the beverage inside the container 10 leak or be spilled upon the walls (internally or externally of them), or upon contact of a liquid, such as rain, with the outside of the container 10.

A cardboard material is particularly preferred for reasons of cost, weight and ease of recycling, and because cardboard can be easily and inexpensively embossed and/or printed upon to allow identification and branding of the contents of the container 10. In particular, multi-ply cross-laminated duplex board has been found to provide suitable structural stiffness. If included, the top and bottom panels 39, 40, 51, 52 and/or end covers 610, 611 are preferably formed of a plastics material since a user is most likely to use them to support the container 10 on a surface. By forming them of plastic, any residual liquid on the surface is not absorbed by the cardboard material forming the rest of the container 10 and the integrity of the container 10 is maintained.

A cover layer, for example a flexible laminate or paper layer, may also be provided around the walls 11, 12, 13, 14, 15, 16 to add further water resistance to the container 10. In addition, the cover layer may include logos and/or product information relating to the beverage inside the container 10.

Although, again as noted, the walls 11, 12, 13, 14, 15, 16 need not necessarily be formed of a flexible material, again preferably a cardboard material may be employed even so, for reasons of cost, weight and so forth. Although the foregoing describes a number of alternative arrangements for the construction and configuration of the container 10, it is to be that these are merely exemplary and that other forms are contemplated. In particular, in terms of sustainability of materials, ease of recycling, cost, weight and so forth, it is not essential that the container 10 be formed of multiple separate or separable parts.

### The Beverage Dispensing Arrangement

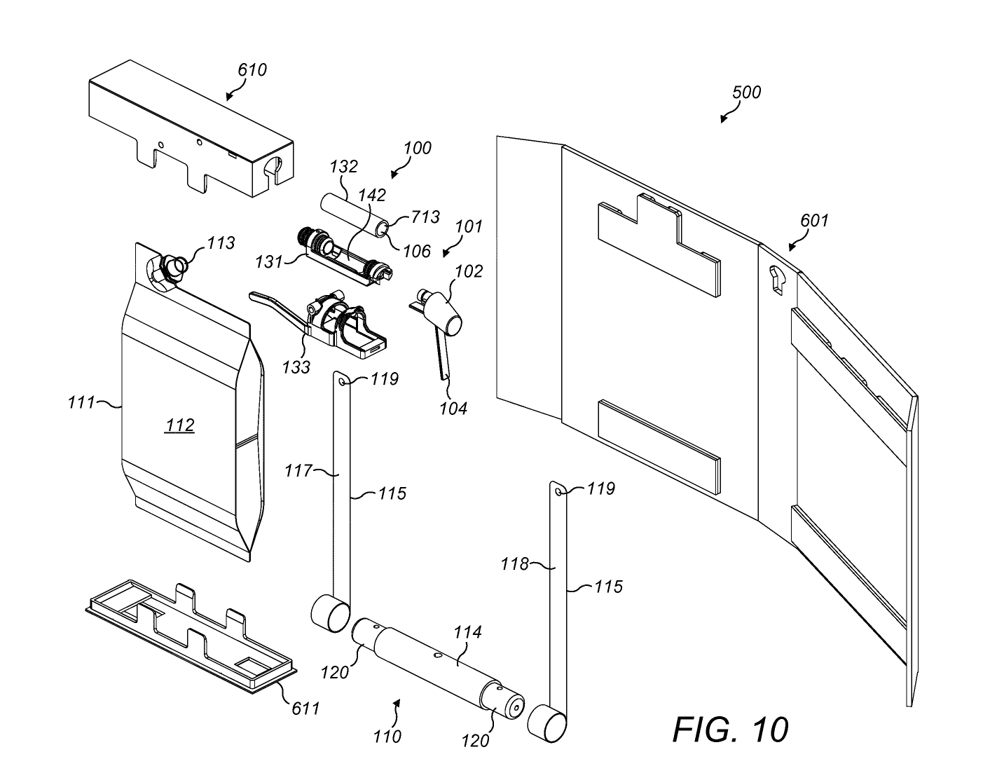

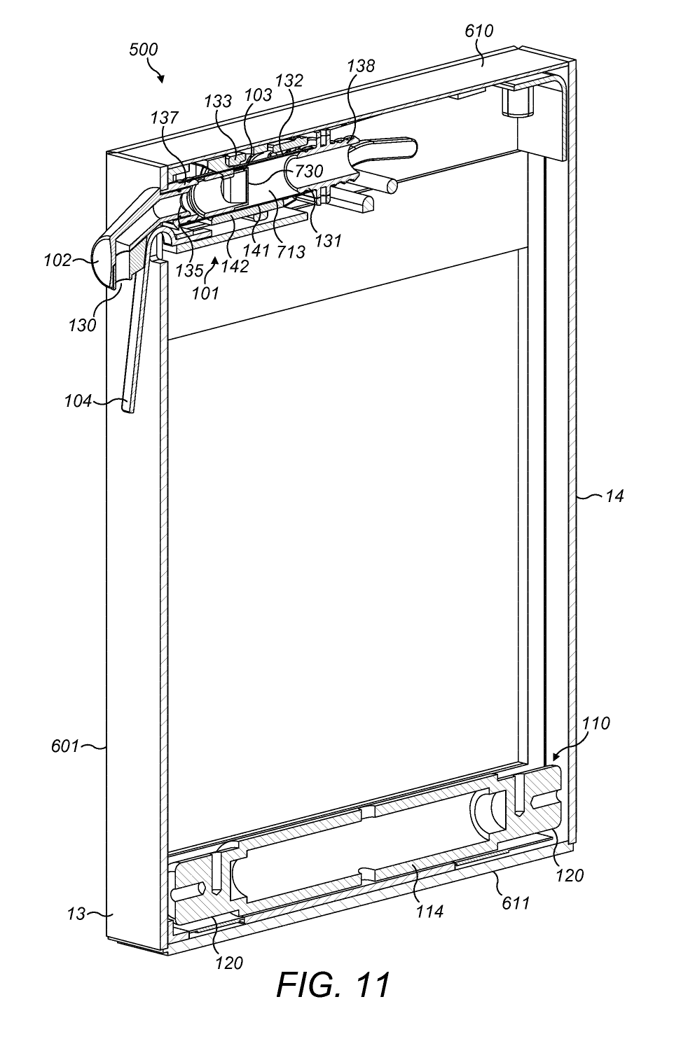

FIG. 10 illustrates an exploded view of the module 500 when constructed in a similar manner to the sixth embodiment shown in FIGS. 9A and 9B and including the beverage dispensing arrangement 100. In FIG. 10 the reference numerals referring to the features of the housing 601 and first and second end covers 610, 611 have been omitted for clarity, although the features are the same as described above. FIGS. 11 to 13 illustrate the components of the module 500 and beverage dispensing arrangement 100 in further detail. The beverage dispensing arrangement 100 generally comprises a pressurising arrangement 110 for applying pressure to a compressible beverage reservoir 111 containing a beverage. Compressing the reservoir 111 causes the beverage in turn to flow along the outlet arrangement 101, which comprises the outlet nozzle 102, the dispensing valve 103 and a dispensing conduit 106 formed between the body of the reservoir 111 and the outlet nozzle 102. The beverage presses against the dispensing valve 103 until opened by the dispensing actuator 104, when beverage is driven from the reservoir 111, along the dispensing conduit 106, through the dispensing valve 103 and out of the container 10 via the outlet nozzle 102. Preferably there are no air gaps within the reservoir 111, such that as beverage is ejected the internal volume of the reservoir 111 is reduced.

### The Pressurising Arrangement

The reservoir 111 comprises a pouch 112 formed of a flexible membrane having an outlet 113 connected and sealed to the outlet arrangement 101. The construction of the pouch 112 will be described in more detail below. The pressurising arrangement 110 comprises a roller 114 and a resilient bias means 115 or mechanism. An end of the pouch 112 is attached along the length of the roller 114. The resilient bias means 115 is arranged to roll the roller 114 such that the internal volume of the pouch 112 is reduced by wrapping the pouch 112 around the roller 114 as beverage is dispensed from the pouch 112.

The roller 114 is substantially elongate and extends from the first minor side wall 13 to the second minor side wall 14. As illustrated, the roller 114 has a circular cross-section and has the same diameter along its length. Such an arrangement is preferred in order to prevent the creation of air pockets within the pouch 112 and to ensure that the pouch 112 remains taught during dispensing. In alternative embodiments the roller 114 may have any other suitable cross-sectional shape, for example square, rectangular, hexagonal, triangular or octagonal. Furthermore, the diameter of the roller 114 may vary along its length, for example by being larger in the centre and decreasing towards the ends of the roller 114. The roller 114 may be shaped such that it has the smallest diameter where the pouch 112 has the greatest thickness, such that the overall thickness of the pouch 112 and roller 114, when the pouch 112 has been wrapped around the roller by several turns, is equal along the length of the pouch 112 and roller 114.

The roller 114 may be formed from any suitable material, such as cardboard or a lightweight plastics material, and may be hollow (i.e. tubular) or substantially solid. Cardboard is preferred for sustainability reasons.

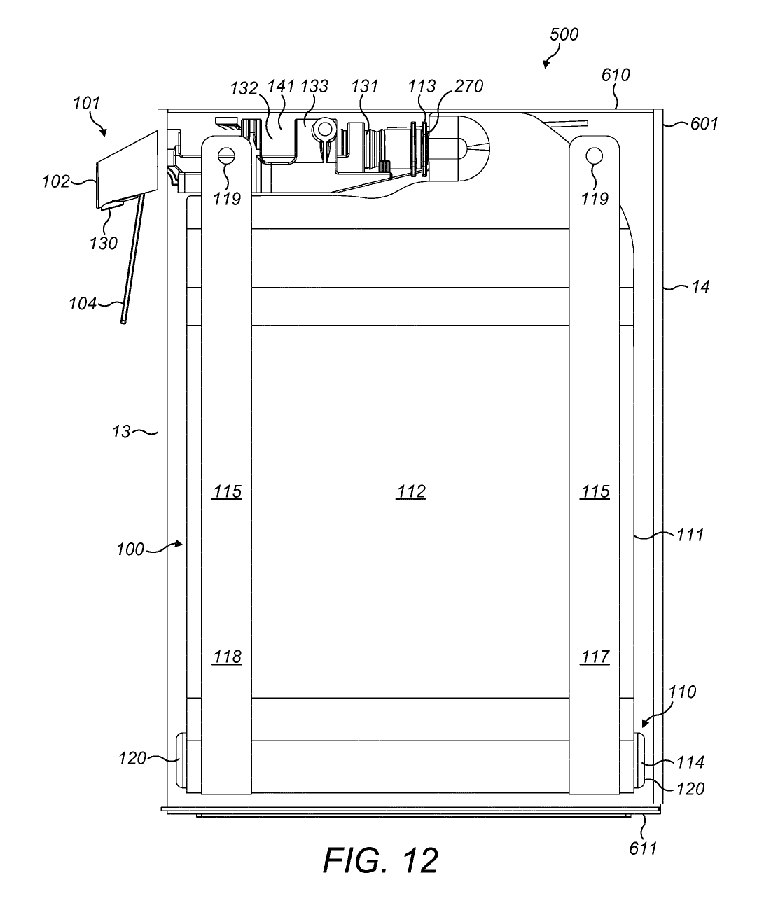

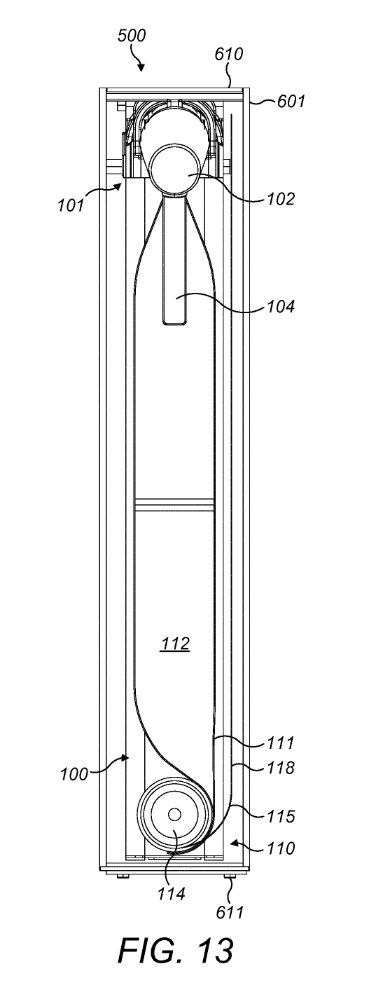

The pouch 112 may be attached all the way along, or only partly along (for example, only at the sides of) the roller 114. In particular, the end of the pouch 112 opposite the outlet 113 (i.e. the lower end in FIGS. 12 and 13) may be adhered along its length the roller 114. Alternatively, only a central portion of the lower end of the pouch 112 may be attached to the roller 114.

The resilient bias means 115 is attached to the roller 114 to resiliently bias the roller 114 by inducing a torque such that the roller 114 will rotate and apply a compressive force to the pouch 112 and any beverage inside it. Thus if no liquid pressure resists the compressive force the roller 114 will continue to rotate and the pouch 112 will wrap around it until it reaches the end of its range at the top of the container 10. In doing so, the internal volume within the pouch 112 will be reduced.

In the illustrated embodiments the resilient bias means 115 comprises first and second springs 117, 118, each attached at either end of the roller 114. Preferably the springs 117, 118 are constant force roll springs and are formed of steel. The springs 117, 118 store mechanical energy such that they will apply a rotational force to the roller 114. The free end of each spring 117, 118 extends from the roller 114 to the top of the container 10 where it is attached to the container 10 by attachment means, such as one of the aforementioned dispensing mounts 39, 51, 62, 613, housings 30, 50, 60, 340, 601, first end cover 610, and/or walls 342, 343. For example, as illustrated in FIGS. 10 to 13, each spring 117, 118 comprises an aperture 119 for attachment to hooking means (not shown), such as a peg or hook, on the inner side of the first end cover 610.

In the illustrated embodiments the springs 117, 118 are wrapped around the roller 114. However, in alternative embodiments the springs 117, 118 may be attached to either end of the roller 114, for example by being mounted on pins protruding from the end faces of the roller 114. As best illustrated in FIG. 13, the free ends of the springs 117, 118 extend to the top of the container 10 between the pouch 112 and one of the major walls 11, 12 of the container 10. Such an arrangement is preferred as a relatively large pouch 112 may be included within the container 10. In an alternative arrangement the pouch 112 does not overlap with the springs 117, 118 such that the springs 117, 118 are located between the pouch 112 and the first and second minor side walls 13, 14. Although such an arrangement may improve ease of assembly, for a fixed size of beverage container 10 the pouch 112 would need to be smaller and thus contain a smaller amount of beverage.

The springs 117, 118 may be mounted on the roller 114 in recessed regions 120, having a smaller diameter than the rest of the roller 114, towards the ends of the roller 114. When the roller 114 reaches the top of its range and the pouch 112 has entirely wrapped around it, the provision of the springs 117, 118 in the recessed regions 120 has been found to ensure that there is less residual beverage left in the pouch 112. The recessed regions 120 may be formed integrally with the rest of the roller 114. Alternatively, the roller 114 may be formed from a first tube being inserted into the second tube of a larger internal diameter. The second tube is shorter than the first tube and is centrally positioned along the first tube, thereby exposing either end of the first tube. These exposed ends of the first tube form the recessed regions 120.

It will be appreciated that there are various other suitable arrangements for the springs 117, 118. Only one or more than two springs 117, 118 may be attached between the roller 114 and the top of the container 10. The springs 117, 118 may be any other suitable type of spring, such as spiral or torsion springs. Furthermore, the springs need not be attached to the top of the container 10 and may instead only be attached to the roller 114.

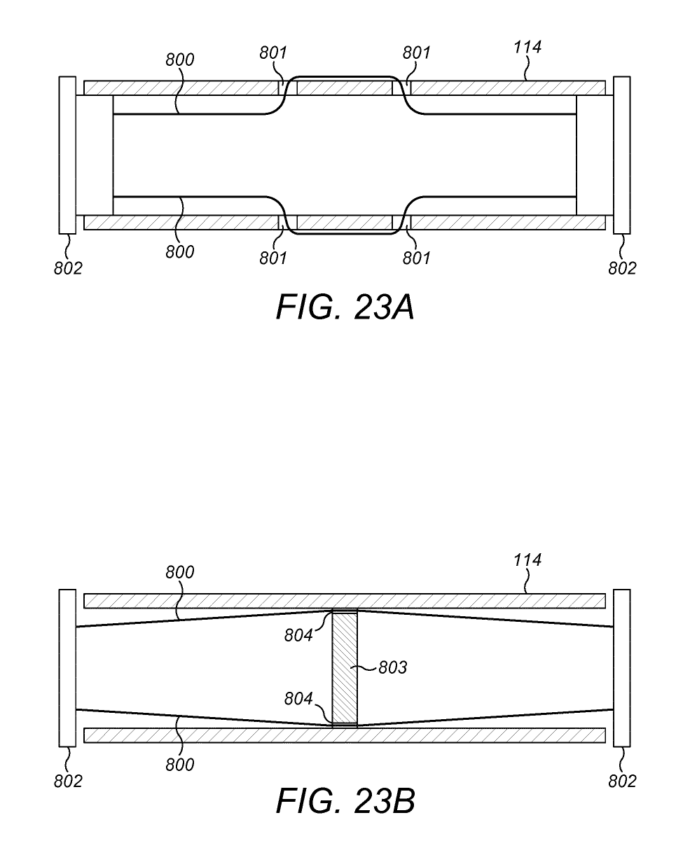

The resilient bias means 115 may alternatively comprise at least one elongate elastic (e.g. elastomeric) member attached to the roller 114 and arranged to induce a torque in the roller 114 such that it rotates. Two suitable arrangements for the formation of the resilient bias means 115 by elastic members are shown in FIGS. 23A and 23B. As illustrated, preferably the roller 114 is substantially hollow and the at least one elastic member 800 extends through it between the minor side walls 13, 14 of the container 10.

Preferably the at least one elastic member 800 is anchored to the roller 114 towards its centre, as in FIG. 23A. Two elastic members 800 are provided, each anchored in two apertures 801 spaced equally on either side of the centre of the elongate axis of rotation of the roller 114. Each end of the elastic members 800 is attached to the anchor members 802 at either end of the roller 114. The anchor members 802 are not rotatable, but can slide up and down the first and second minor side walls 13, 14 of the container 10. For example, the anchor members 802 are square or rectangular (i.e. include two parallel edges) and are mounted in the slots 44, 68 or slide up and down the inside of the first and second minor side walls 13, 14 and are constrained from rotation by the inner faces of the first and second major side walls 11, 12. In the embodiment of FIG. 23B, an interior anchor member 803 is provided within the roller 114. The interior anchor member 803 comprises a circular disc having an aperture 804 adjacent to its periphery for each elastic member 800 to pass through. It will be appreciated that in both of the embodiments of FIGS. 23A and 23B the two elastic members 800 could be joined at their ends to form elastic bands, or more than two elastic members 800 could be provided.

During assembly at least one of the anchor members 802 is rotated to helically wind each elastic member 800 around itself as well as, if present, the other elastic member 800. Once the anchor members 802 are mounted in the slots 44, 68, the helical winding of the elastic member(s) will resiliently bias and induce a torque in the roller 114 such that it rotates and wraps the pouch 112 around it when beverage is dispensed from its internal volume. The anchoring of the elastic members 800 towards the centre of the roller 114 ensures that, during the unwinding of the elastic members 800, the roller 114 is maintained in a horizontal configuration. If it is not maintained in the horizontal configuration the roller 114 is prone to become jammed.

The at least one elastic member 800 may be formed of polymer, latex, theraband, neoprene, silicone or the like. Preferably the at least one elastic member 800 is maintained within its elastic range between when the pouch 112 is full and when it is empty, such that it always provides a substantially equal compressive force to the pouch 112 over its range of expansion and contraction. It has been found that a circular cross section is particularly suitable for achieving such an effect as it comprises a relatively high number of cross-links in various directions which prevent stress relaxation. This is particularly the case when compared to an elastic member 800 having a substantially planar cross-section.

In an alternative embodiment, first and second elastic members 800 may each be attached at either end of the roller 114 and extend to the top of the container 10. The tensile force of the at least one elastic member 800 may resiliently bias the roller 114 into rolling. The at least one elastic member 800 could, for example, be under maximum tension when the pouch 112 is full of beverage and may become progressively less taut as beverage is emptied.

### The Pouch

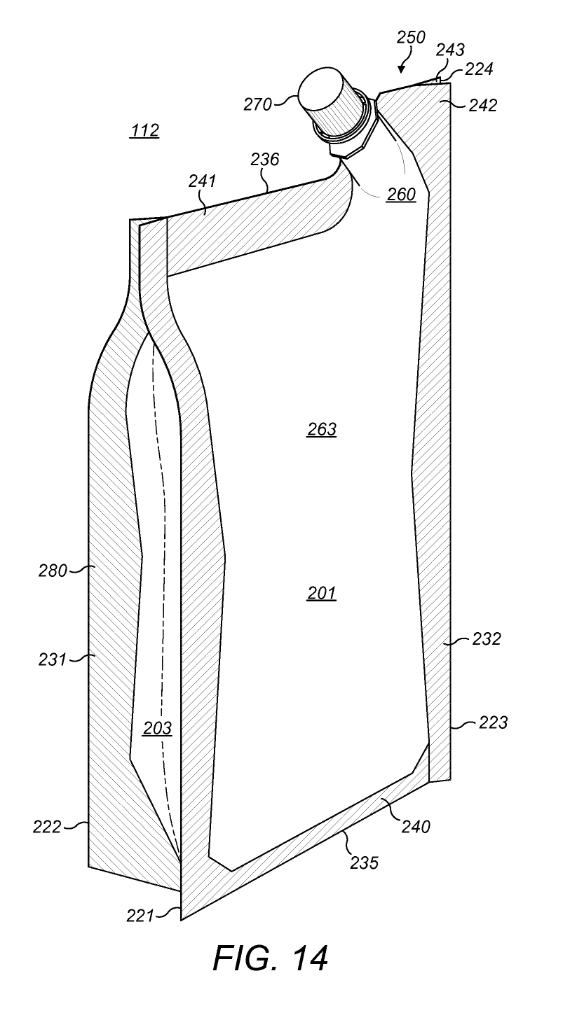

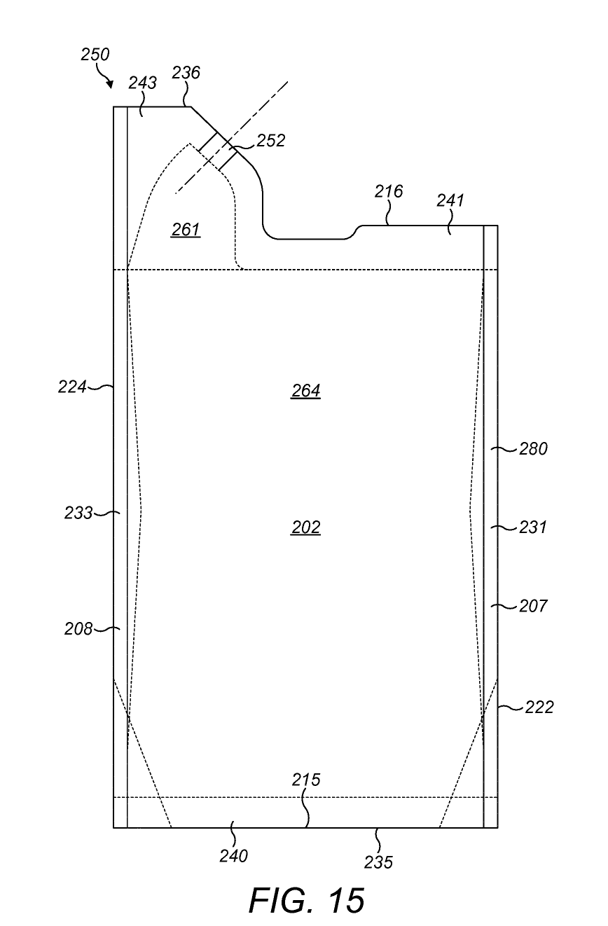

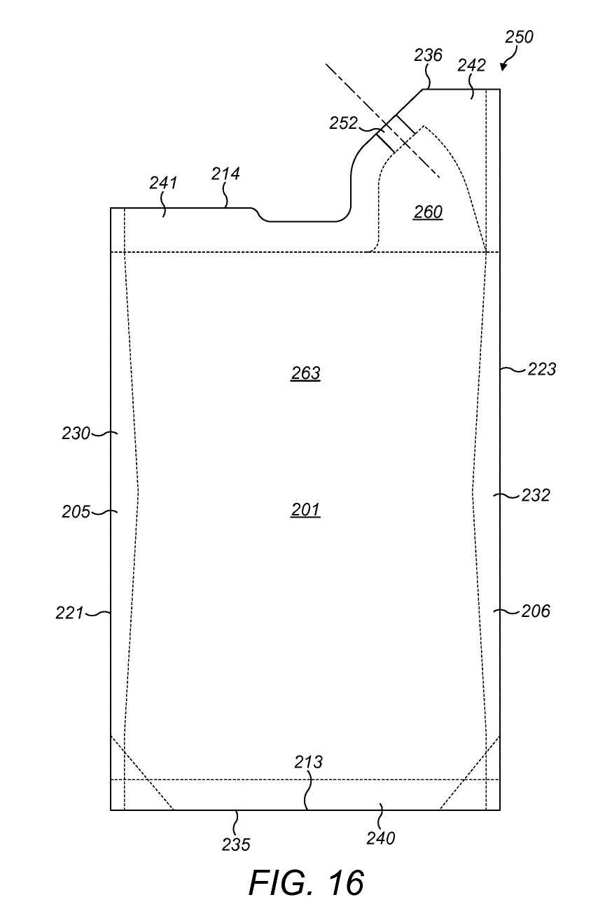

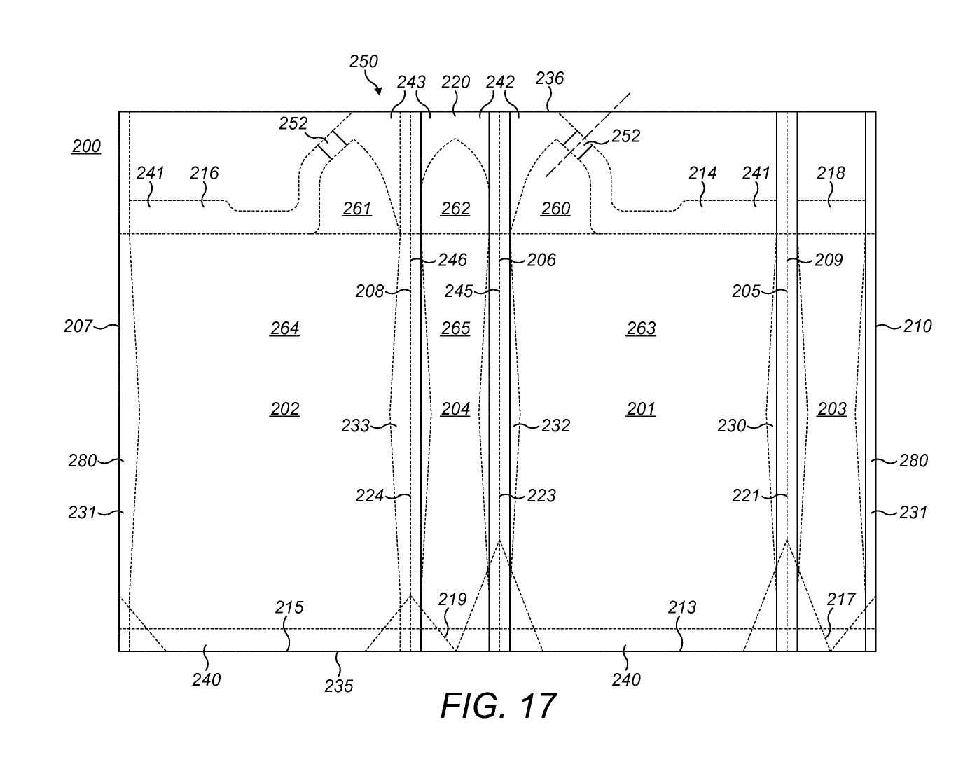

FIGS. 14 to 17 illustrate an embodiment of the pouch 112 of the present invention. It is noted that the dotted lines and cross-hatching are intended to be merely schematic representations of the areas where panels have been attached to other panels. This is particularly the case with FIG. 17, which is merely a schematic view of a blank 200 for forming the pouch 112 with the areas shown where the panels would be attached to one another in the assembled pouch 112.

The pouch 112 is formed from a substantially flexible, impermeable, laminar membrane. The laminate is preferably of a type suitable for containing alcoholic beverage and thus withstands exposure to alcohol for a significantly long period of time and does not degrade or delaminate. The laminate also preferably has low fluid transmission rates to ensure that the composition of the beverage does not vary over the time, for example by preventing water and alcohol vapour escaping or allowing oxygen to enter. Further preferably, the laminate is arranged to be welded/sealed and the material is such that alcohol does no degrade the welds/seals. It is also preferred if the laminate does not degrade into the beverage such that the flavour of the beverage is changed during storage in the pouch 112.

The laminate may comprise at least one metallised layer and at least one weld layer. The laminate may comprise a number of layers of PE (polyethylene), PET (polyethylene terephthalate), PETMET (PET metallised with a metal, such as aluminium, of negligible thickness), aluminium (referred to as ALU), EVOH (Ethylene vinyl alcohol), PP (polypropene), OPA (polyamide), silicon oxide and aluminium oxide.

The pouch 112 comprises substantially opposing first and second major side panels 201, 202 and substantially opposing first and second minor side panels 203, 204. Each of the side panels 201, 202, 203, 204 comprises first and second major edges 205, 206, 207, 208, 209, 210, 211, 212, 245, 246 and first and second minor edges 213, 214, 215, 216, 217, 218, 219, 220. The side panels 201, 202, 203, 204 are attached to one another along the major edges 205, 206, 207, 208, 209, 210, 211, 212, 245, 246 at first, second, third and fourth corners 221, 222, 223, 224. The first major edge 205 of the first major side panel 201 is connected to the first major edge 209 the first minor side panel 203 along the first corner 221. The second major edge 210 of the first minor side panel 203 is connected to the first major edge 207 of the second major side panel 202 along the second corner 222. The second major edge 206 of the first major side panel 201 is connected to the first major edge 245 of the second minor side panel 204 along the third corner 223. The second major edges 208, 246 of the second major and minor side panels 202, 204 are connected along the fourth corner 224. The first minor edge 213 of the first major side panel 201 is attached to a first minor edge 215 of the second major side panel 202 and the second minor edge 214 of the first major side panel 201 is attached to a second minor edge 216 of the second major side panel 202.

The pouch 112 further comprises first, second, third and fourth sealed regions 230, 231, 232, 233 (schematically represented by the dotted lines and cross-hatching) extending along and located adjacent to the first, second, third and fourth corners 221, 222, 223, 224 respectively. The first, second, third and fourth sealed sealed regions 230, 231, 232, 233 are formed as relatively stiff (i.e. stiffer than a single layer of the laminate) seals between the side panels 201, 202, 203, 204. Each of the first, second, third and fourth sealed regions 230, 231, 232, 233 extend away from the respective corner 221, 222, 223, 224 by a decreasing distance on either side of a central portion of the respective corner 221, 222, 223, 224. The term “central portion” refers to the area around midway between the minor edges 213, 214, 215, 216, 217, 218, 219, 220 of each of the side panels 201, 202, 203, 204. Therefore, each of the sealed regions 230, 231, 232, 233 may extend from the respective corner 221, 222, 223, 224 in a substantially triangular shape, with the tip of the triangle being located in the central portion of the respective corner 221, 222, 223, 224.

This profile has been found to be particularly effective in maintaining the pouch 112 in a suitable shape as it is rolled around the roller 114. In particular, the profile prevents the first and second major side panels 201, 202 from expanding significantly, when filled with beverage and pressurised, such that the pouch 112 interferes with the side walls 11, 12, 13, 14 of the container 10. This is due to the first, second, third and fourth sealed regions 230, 231, 232, 233 being widest in the regions of the side panels 201, 202, 203, 204 where the greatest expansion of the side panels 201, 202, 203, 204 would occur when the pouch 112 is filled with beverage. The wider parts prevent such a large expansion. The narrower ends of the first, second, third and fourth sealed regions 230, 231, 232, 233 enable the pouch 112 to have a larger internal volume and thereby hold relatively more beverage.

Each of the four corners 221, 222, 223, 224 extend from a first end 235 at the bottom of the pouch to a second end 236 at the top of the pouch 112. Each of the first, second, third and fourth sealed regions 230, 231, 232, 233 increasingly extend away from the respective corner 221, 222, 223, 224 towards the first end 235 such that these portions of each of the first, second, third and fourth sealed regions 230, 231, 232, 233 comprise a “K” or triangular profile at the first end 235, as is best illustrated in FIG. 17. The point of the triangle is coincident with each corner 221, 222, 223, 224.

The first and third sealed regions 230, 232 start to increasingly extend away from the first and third corners 221, 223 towards the first end 235 closer to the first end 235 than the second and fourth sealed regions 231, 233 start to increasingly extend away from the second and fourth corners 222, 224 towards the first end 235. Thus the triangular profile of the first and third sealed regions 230, 232 adjacent the first end 235 is smaller than the triangular profile of the second and fourth sealed regions 231, 233 adjacent the first end 235. In particular, the angle of the triangular profile of the first and third sealed regions 230, 232 is around 45° and the triangular profile of the second and fourth sealed regions 231, 233 is at an angle of less than 45° to the second and fourth corners 222, 224.

This profile adjacent to the first end 235 has been found to assist in the start of the rolling of the pouch 112 around the roller 114. When the pouch 112 is filled with beverage, the first and second major side panels 201, 202 bulge outwards and over the roller 114 and these bulges may prevent the roller 114 from initially rotating. By positioning the second major side panel 202 adjacent to the roller 114, the larger triangular profiles of the second and fourth sealed regions 231, 233 create a “lead-in” for the roller by raising the bulge above the roller 114. Therefore, the pressurising arrangement 110 will be able to initiate rolling of the roller 114 along the lead-in and thereby overcome the bulge in the first and second major side panels 201, 202.

A first end sealed region 240 is provided between, and adjacent to the first minor edges 213, 215 of, the first and second major side panels 201, 202. The first end sealed region 240 extends between the first, second, third and fourth sealed regions 230, 231, 232, 233.

An outlet portion 250 is provided at the second end 236 of the pouch 112. A second end sealed region 241 is provided between, and adjacent to the second minor edges 214, 216 of, the first and second major side panels 201, 202 and extends from the first and second sealed regions 230, 231. A third end sealed region 242 is also provided between the first major side panel 201 and second minor side panel 204 adjacent to the third sealed region 242. A fourth end sealed region 243 is also provided between the second major side panel 201 and second minor side panel 204 adjacent to the fourth sealed region 243. The outlet portion 250 further comprises an aperture 252, forming the pouch outlet 113, located between the second minor edges 214, 216 of the first and second major side panels 201, 202 and bounded by the second, third and fourth end sealed regions 241, 242, 243.

The outlet portion 250 further comprises protruding portions 260, 261, 262 of the first and second major side panels 201, 202 and second minor side panel 204. As best shown in FIG. 17, each of the first and second major side panels 201, 202 and second minor side panel 204 comprise a substantially rectangular portion 263, 264, 265 and the protruding portions 260, 261, 262 extend from these rectangular portions 263, 264, 265 at the second end 236 of the pouch 112. The aperture 252 preferably extends from the protruding portions 260, 261 at an angle of 45° to the longitudinal axis between the first and second ends 235, 236. The outlet portion 250 is arranged to be connected to the outlet arrangement 101 of the beverage dispensing arrangement 100.

An adapter 270 or the like may be sealed to the aperture 252 in order to provide the connection therebetween. The adaptor 270 may comprise a conduit entering the internal volume of the pouch 112 and connection means for connecting the conduit to the outlet arrangement 101. The adaptor 270 may be formed of the same material, but in a stiffened version, as the inner surface of the pouch 112 such that it can be welded thereto to form a water-tight seal.

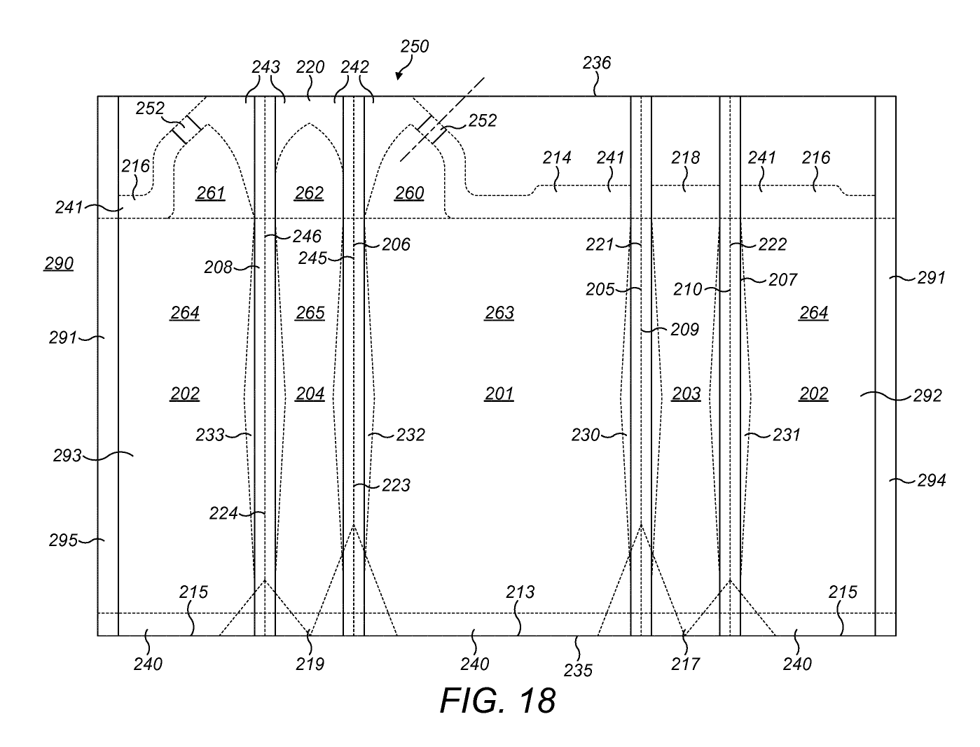

In the embodiment of FIGS. 14 to 17 a longitudinal seam 280 between free ends of the laminate is formed at the second sealed region 231. However, the longitudinal seam 280 may be formed at any other suitable location in the pouch 112. FIG. 18 illustrates a further embodiment of a blank 290 for forming the pouch 112 of the present invention in which the longitudinal seam 291 is provided in the second major side panel 202. The second major side panel 202 is formed of first and second parts 292, 293 with free ends 294, 295. The free ends 294, 295 are sealed together, for example in a lap seal, in the assembled pouch 112. In yet further embodiments the pouch 112 may be formed from separate sheets of laminate, each forming one of the major and minor side panels 201, 202, 203, 204 and the seams therebetween are formed by the sealed regions 230, 231, 232, 233, 240, 241, 242, 243.

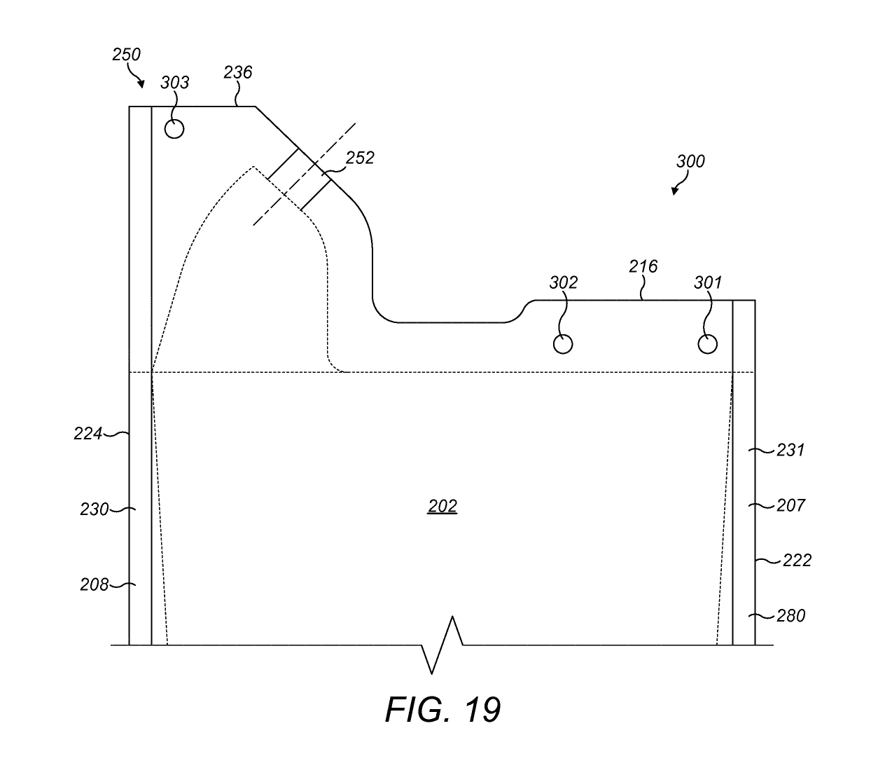

Furthermore, the pouch 112 may comprise attachment means 300 for attaching the pouch 112 to the rest of the module 500. In particular, as illustrated in FIG. 19, a plurality of apertures 301, 302, 303 may be provided at the second end 236 of the pouch 112 for connecting the pouch 112 to the container 10 via, for example, the aforementioned dispensing mounts 39, 51, 62, housings 30, 50, 60, 340 or walls 342, 343. One aperture 301 may be provided in the corner of the third and fourth sealed regions 242, 243 and two apertures 302, 303 may be provided through the second end sealed region 241. By supporting the pouch 112 at such positions, the outlet portion 250 is maintained in an open position such that it cannot be creased shut. Furthermore, the pouch 112 remains sufficiently taught during wrapping around the roller 114 that it empties efficiently during beverage dispensing.

The sealed regions 230, 231, 232, 233, 240, 241, 242, 243 are preferably, as illustrated, fin seals. The term “fin seal” is known in the art and refers to a seal in which the laminate is attached onto itself on the same surface. This is in contrast to a “lap seal”, in which the laminate is attached onto itself at an overlap such that opposing surfaces are attached to each other. However, it will be appreciated that in embodiments of the invention the sealed regions 230, 231, 232, 233, 240, 241, 242, 243 may be lap seals. The sealed regions 230, 231, 232, 233, 240, 241, 242, 243 may be formed by heat sealing and/or welding the laminate together.

In the aforementioned embodiments the main body of the internal volume of the pouch 112 forms a generally rectangular cuboidal shape, predominantly due to the predominantly rectangular shape of the major and minor side panels 201, 202, 203, 204. However, it will be understood that other shapes of the pouch 112 fall within the scope of the present invention. Furthermore, the pouch 112 may not comprise a second minor side panel 204 and the first and second major side panels 201, 202 may be sealed together directly along their second major edges 206, 208.

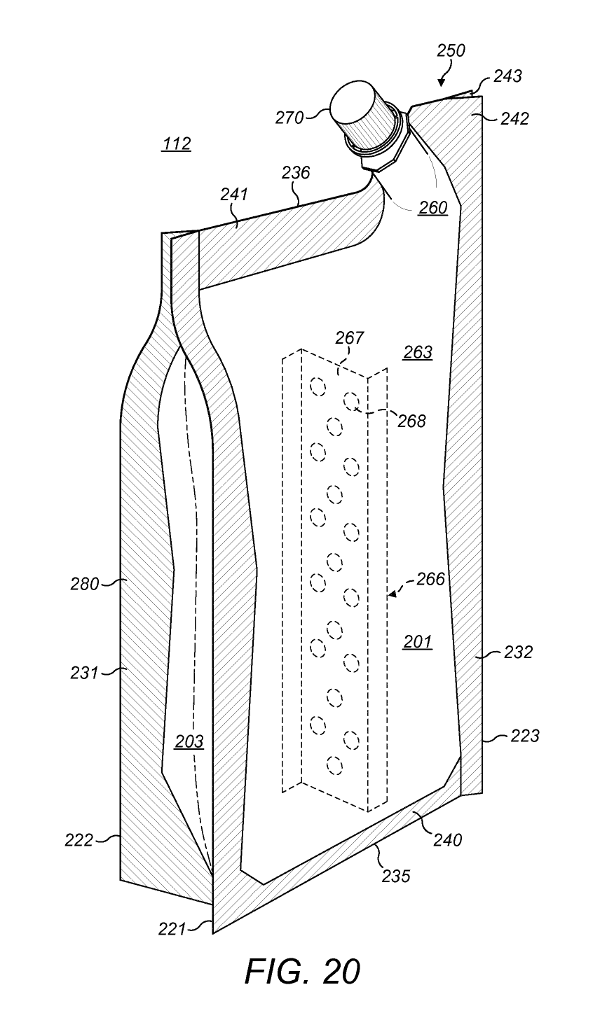

FIG. 20 illustrates a further embodiment of the pouch 112 wherein it comprises an internal gusset 266 attached within the pouch 112 to each of the major side panels 201, 202. The internal gusset 266 is arranged to constrain the expansion of the areas of the major side panels 201, 202 adjacent to the internal gusset 266 to the width of the gusset 266. The gusset 266 comprises a constraining sheet 267 with a plurality of holes 268 for allowing beverage to pass through it. The gusset 266 may be formed in an “s” shape, or a “u” shape, with the edge regions welded or adhered to the inner surfaces of the major side panels 201, 202.

Furthermore, when the pouch 112 is assembled, the third and fourth sealed regions 242, 243 may be folded towards the adaptor 270. As a result, the outlet portion 250 remains open as the second minor side panel 204 provides a separation between the protruding portions 260, 261 through which beverage may pass.

### The Outlet Arrangement

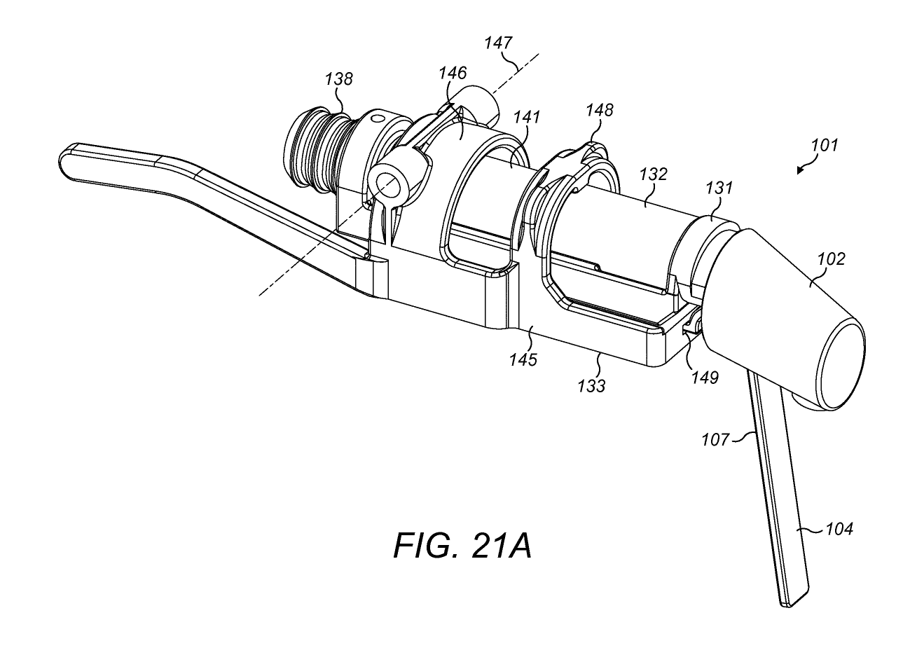

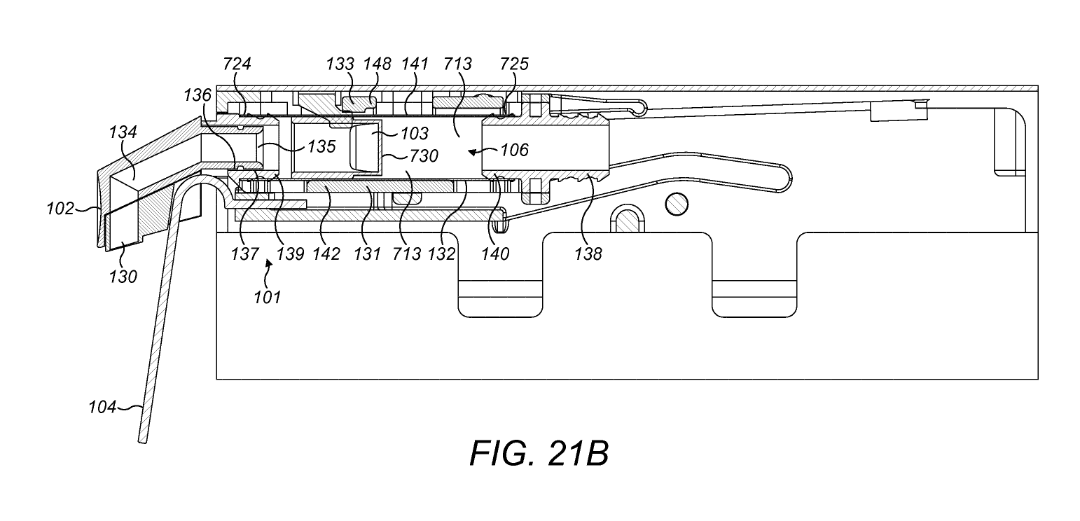

An embodiment of the outlet arrangement 101 is illustrated in detail in FIGS. 10, 11, 12 and 21A, 21B, 22A and 22B. The outlet arrangement 101 comprises the outlet nozzle 102, an intermediary adapter 131, a valve arrangement 132 and a lever arrangement 133. The outlet nozzle 102 comprises an outlet aperture 130 at one end of an internal passageway 134 and an inlet aperture 135 and nozzle inlet adapter 136 at the opposing end of the internal passageway 134. The nozzle inlet adapter 136 comprises a hollow tube for mating to the intermediary adapter 131.

The outlet nozzle 102 is mounted on and projects from the first minor side wall 13 and is generally offset from the centre line parallel to the minor edges of the first minor side wall 13. When the second end wall 16 stands on a surface, the outlet nozzle 102 is located in the upper half of the first minor side wall 13. However, it will be appreciated that the module 500 may be adapted such that the outlet nozzle 102 is on any of the other side walls 11, 12, 14. Although it is not essential that the outlet nozzle 102 be positioned in the upper half of the side walls 11, 13, 12, 14, by locating the outlet nozzle 102 in that upper half, sufficient height is provided to allow a glass other drinks receptacle to be placed underneath the outlet nozzle 102 so that beverage can be dispensed directly into that drinks receptacle whilst it sits on a surface next to the container 10.

The intermediary adapter 131 is sealed and connected at a first outer connector 137 to the nozzle inlet adapter 136 and at a second outer connector 138 to the pouch outlet 113. The first outer connector 137 may comprise a hollow tube which receives the hollow tube of the nozzle inlet adapter 136 and the second outer connector 138 may comprise a hollow tube inserted into connecting means of the pouch adaptor 270. The intermediary adapter 131 further comprises first and second inner connectors 139, 140, each in fluid communication with the first and second outer connectors 137, 138 respectively, in the form of hollow tubes extending towards one another. The intermediary adapter 131 also comprises a valve support wall 142 located underneath the valve arrangement 132, which will be described in further detail hereinbelow.

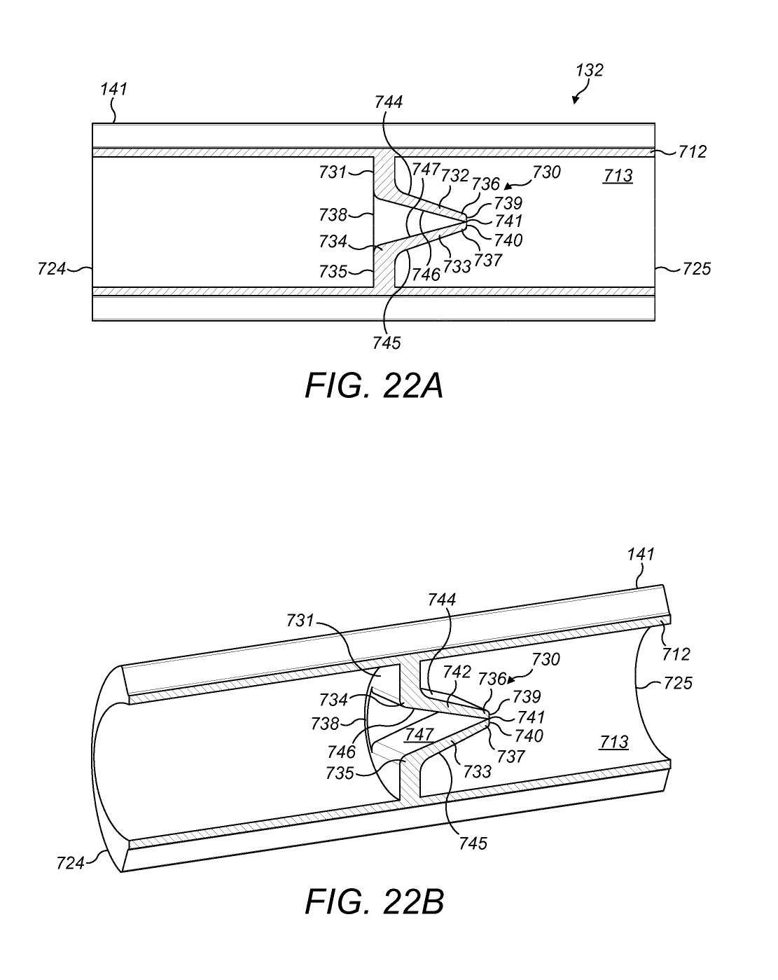

The valve arrangement 132 comprises a tube 141 and the dispensing valve 103 is disposed therein. The dispensing valve 103 may be a one-way or check valve, which only opens when actuated by the dispensing actuator 104, and prevents the ingress of air into the reservoir 111 to prevent the beverage contained therein from deteriorating. Preferably the dispensing valve 103 is a duckbill valve 730 and the duckbill valve disclosed in UK Patent Application No. 1411147, which is incorporated herein by reference, is particularly suitable. In such an arrangement, illustrated in FIGS. 22A and 22B, the tube 141 comprises a tube wall 712 forming an elongate passageway 713 having a first end 724 sealed to the first inner connector 139 and a second end 725 sealed to the second inner connector 140.

The dispensing conduit 106 therefore leads from the pouch outlet 113 to, in order of fluid flow during dispensing, the second outer connector 138, the second inner connector 140, the passageway 713, the first inner connector 140, the nozzle inlet adapter 136, the internal passageway 134 and, finally, the outlet aperture 130.

The dispensing valve 103 is formed of the duckbill valve 730, which comprises a mounting wall 731 attached to the inner surface of the tube wall 712. First and second valve walls 732, 733 extend from the mounting wall 731 at first ends 734, 735 to second ends 736, 737. The first and second valve walls 732, 733 are separated at their first ends 734, 735 by an opening 738 formed in the mounting wall 731. The opening 738 is substantially in the shape of a rectangle with two opposing curved edges. As illustrated, the opening 738 is arranged such that there is a portion of the mounting wall 731 between the tube wall 712 and opening 738 (i.e. the tube wall 712 and opening 738 are separated). However, in other embodiments the curved edges of the opening 738 may be formed by the tube wall 712 itself.

The first and second valve walls 732, 733 converge towards each other from the opening 738 at their first ends 734, 735 and contact each other at their second ends 736, 737. Thus, when viewed in the third plane (i.e. longitudinal-transverse plane) as in FIG. 22A, the inner surfaces 744, 745 of the first and second valve walls 732, 733 are at an angle of less than 180° to one another and thereby define a V-shape. The second ends 736, 737 define between valve tips 739, 740 a valve mouth 741 which, when closed, is in the form of an elongate and straight slit. When closed the valve mouth 741 is elongate along the lateral axis such that it extends orthogonal to the longitudinal axis 714 along which the tube 141 extends. The valve mouth 741 is resiliently biased to be substantially in the closed position, although the valve mouth 741 will not be sealed in such a position until an external pressure is applied to the first and second valve walls 732, 733. When opened the valve mouth 741 is in the shape of an oval or vesica piscis (i.e. oval shaped with pointed ends).

The outer edges of the first and second valve walls 732, 733, i.e. the edges in the transverse direction, are attached to the tube wall 712. Thus fluid can only pass through the valve mouth 741. The largest inner and outer surfaces 744, 745, 746, 747 of the first and second valve walls 732, 733, i.e. those which extend from the first ends 734, 735 to second ends 736, 737 between either side of the tube wall 712, are each substantially flat and planar. The thicknesses of the first and second valve walls 732, 733 are substantially constant or reduce from the first ends 734, 735 to the second ends 736, 737.

The tube 141 and duckbill valve 730 are formed from a resilient (i.e. elastomeric) material such that, after being squeezed or otherwise manipulated, it will return to the aforementioned shape in which the valve mouth 741 is closed. Suitable materials include elastomeric polymers, rubbers, butyl rubber, silicone and thermoplastic elastomers. For example, if fluid of a relatively high pressure enters the tube 141 at the first end 724 it will open the valve mouth 741 provided that the fluid on the second end 725 of the tube 141 has a lower pressure. As soon as the pressure equalises at the first and second ends 724, 725 the valve mouth 741 will return to the closed position, although will not be sealed until the pressure at the first end 724 of the tube 141 is greater than the pressure at the second end 725 of the tube 141.

However, in the present invention the valve mouth 741 is openable by squeezing the outside of the tube 141 using the dispensing actuator 104. In particular, the dispensing actuator 104 is operable to apply a compressive force along the lateral direction (i.e. in the plane along which the valve mouth 741 extends when closed) to open the valve mouth 741. This is a result of the elastic deformation of the first and second valve walls 732, 733 urging the valve tips 739, 740 away from each other to compensate for the reduced lateral dimension of the duckbill valve 730.

The dispensing actuator 104 comprises the lever arrangement 133 and a dispensing lever 107 connected to the lever arrangement 133. The dispensing lever 107 is provided outside of the container 10 for a user to actuate, whilst the lever arrangement 133 is provided within the container 10 for translating the actuation of the dispensing lever 107 into the opening of the dispensing valve 103.

The lever arrangement 133 comprises a substantially rectangular, ring-shaped, main body 145 extending from adjacent to the outlet nozzle 102 towards a pivot arm 146 substantially adjacent to the second inner and outer connectors 138, 140. The pivot arm 146 extends from the main body 145 upwards and around the intermediary adapter 131 and valve arrangement 132 from one side of the ring of the main body 145 to the opposing side. The pivot arm 146 is attached to the container 10 such that it is pivotable about a pivot axis 147. For example, a rod (not shown) may extend through a passageway in the pivot arm 146 and be inserted at either end into apertures in the first end cover 610.

The lever arrangement 133 further comprises a valve arm 148 extending from one side of the ring of the main body 145 to the opposing side and disposed over the dispensing valve 103, particularly the valve mouth 741, within the valve arrangement 132. The valve support wall 142 is provided on the opposite side of the valve arrangement 132 to the valve arm 148. The dispensing lever 107 is mounted to the main body 145 by being inserted into a slot 149 in the main body 145 adjacent to the outlet nozzle 102. The valve arm 148 is located towards the dispensing lever 107 from the pivot arm 146.

The pressurising arrangement 110 pressurises the beverage against the dispensing valve 103 when it is closed. The dispensing actuator 104 is operable to dispense beverage from the valve mouth 741 such that the overpressure causes beverage to be ejected from the opening. In particular, when the dispensing lever 107 is pressed downwards, the main body 145 and valve arm 148 move downwards such that the lever arrangement 133 pivots about the pivot axis 147. The valve arm 148 also thereby moves downwards and compresses the dispensing valve 103 against the valve support wall 142 such that the valve mouth 741 opens.

### Assembly and Operation of Module

During assembly of, for example, the sixth embodiment of the container 10, the intermediary adapter 131, lever arrangement 133 and valve arrangement 132 are connected to one another and attached to the first end cover 610. The roller 114 and resilient bias means 115 are subsequently attached to one another and mounted to the first end cover 610. The roller 114 and resilient bias means 115 are placed in a rig to extend the roller 114 to its fully extended position. The pouch 112 is filled with beverage and attached to the roller 114 at its lower end and to the first end cover 610 and its upper end. The container 10 is then constructed and mounted with the first end cover 610, for example by wrapping the housing 601 around the pouch 112, adhering the third minor housing panel 606 to the first minor housing panel 604, and then moving the housing 601 upwards such that the protrusions 615 mount within the recesses 625. The second end cover 611 is then mounted to the bottom of the housing 601 by fitting the protrusions 617 into the recesses 625. Finally, the outlet nozzle 102 is attached to the lever arrangement and intermediary adapter 131 through the apertures 630, 631.

An initial seal may be provided in the outlet arrangement 101 for preventing fluid communication between the internal volume and atmosphere. For example, the initial seal may comprise a foil over the outlet 130 of the outlet nozzle 102. The resilient bias means 115 applies an overpressure relative to atmosphere to the beverage within the pouch 112 by applying a torque to the roller 114. The beverage extends from the internal volume of the pouch 112 (i.e. from between the side panels 201, 202, 203, 204), through the dispensing conduit 106 and to the dispensing valve 103. The dispensing valve 103 and/or dispensing conduit 106 may be attached to the adapter 270 of the pouch 112. The dispensing valve 103 is arranged to prevent beverage flow unless the dispensing actuator 104 is actuated and opens the dispensing valve 103.

Prior to dispensing, the user may remove the initial seal from the outlet arrangement 101. To dispense the beverage from the module 500, the user actuates the dispensing actuator 104, for example by pressing down on a lever as illustrated in FIG. 1. The dispensing actuator 104 is arranged to provide a compressive force against the duckbill valve such that the valve mouth opens. For example, the dispensing actuator is arranged to provide a compressive force directly in line with the valve tips and mouth such that the valve tips move apart. Beverage subsequently flows out of the dispensing valve 103 and out of an opening in the outlet arrangement 101.

As the beverage flows out of the pouch 112 the pressurising arrangement 110 rotates the roller 114 such that pouch 112 wraps around it. Therefore, the internal volume is reduced and an overpressure is maintained in the beverage relative to atmosphere. When the dispensing actuator 104 is released, the dispensing valve 103 closes and beverage no longer flows out of the pouch 112. The beverage applies an opposing force against the torque provided by the resilient bias means 115 such that the roller 114 no longer rotates.

Multiple dispense events may be required until substantially all of the beverage has been dispensed from the module 500. When the internal volume is substantially empty the roller 114 will be located towards the outlet end of the container 10 and the pouch 112 will almost entirely be wrapped around the roller 114. A user may subsequently disassemble the module 500 and the parts may be recycled.

1. A beverage dispensing module comprising:
an outlet arrangement for selectively dispensing beverage;
a pressurising arrangement comprising resilient bias means connected to a roller;
a beverage pouch fluidly connected to the outlet arrangement and mounted with the roller;
wherein the resilient bias means, outlet arrangement and roller are configured to form an overpressure, relative to atmospheric pressure, within the pouch.

2. A beverage dispensing module as claimed in claim 1 wherein the beverage pouch defines a sealed, variable internal volume and the resilient bias means is biased to displace the roller to reduce the internal volume to form the overpressure.

3. A beverage dispensing module as claimed in claim 2 wherein the resilient bias means is arranged to induce a rotational torque in the roller.

4. A beverage dispensing module as claimed in claim 3 wherein the pouch is mounted with the roller such that the pouch is wrappable around the roller by rotation of the roller.

5. A beverage dispensing module as claimed in claim 1 wherein the roller comprises an elongate member and a first end of the pouch is attached to the member at least partially along the elongate dimension of the member.

6. A beverage dispensing module as claimed in claim 1 wherein the resilient bias means comprises at least one spring.

7. A beverage dispensing module as claimed in claim 6 wherein the or each spring is a roll spring.

8. A beverage dispensing module as claimed in claim 7 wherein the resilient bias means comprises a first roll spring attached at a first end of the roller and a second roll spring attached at the second end of the roller.

9. A beverage dispensing module as claimed in claim 8 further comprising a container surrounding the pressurising arrangement and pouch, wherein the ends of the first and second roll springs opposing the ends attached to the roller are mounted to the container towards a first end of the container.

10. A beverage dispensing module as claimed in claim 7 wherein the roll spring(s) is mounted in a recess extending around the circumference of the roller.

11. A beverage dispensing module as claimed in claim 1 wherein the resilient bias means comprises at least one elastic member.

12. A beverage dispensing module as claimed in claim 11 wherein the at least one elastic member anchored to the roller and is helically wound to impart a biasing torque to the roller.

13. A beverage dispensing module as claimed in claim 12 wherein the at least one elastic member is anchored to at least one anchor member provided at an end of the roller, the anchor member being rotationally fixed and slidable within the beverage dispensing module.

14. A beverage dispensing module as claimed in claim 13 wherein the elastic member is anchored to the roller at a central region of the roller.

15. A beverage dispensing module as claimed in claim 13 further comprising a container having a plurality of walls surrounding the pressurising arrangement and pouch, the or each anchor member being slidable along at least one of the walls.

16. A beverage dispensing module as claimed in claim 15 wherein the or each anchor member is slidable along a slot provided in a wall of the container or along a slot provided in a member provided adjacent to the wall of the container.

17. A beverage dispensing module as claimed in claim 15 wherein the container comprises at least two opposing walls and the or each anchor member is slidable between the two opposing walls and the two opposing walls are in contact with the or each anchor member to restrain rotation of the anchor member.

18. A beverage dispensing module as claimed in claim 1 wherein the outlet arrangement comprises a dispensing valve and a dispensing actuator, the dispensing valve being biased to a closed position in which fluid cannot flow though the outlet arrangement and the dispensing actuator being operable to open the dispensing valve upon actuation.

19. A beverage dispensing module as claimed in claim 18 wherein the dispensing valve is a duckbill valve arranged to resist overpressure formed in the pouch unless opened.

20. A beverage dispensing module as claimed in claim 19 wherein the duckbill valve is resiliently deformable and the dispensing actuator comprises a pivotable lever arrangement, said lever arrangement comprising a valve arm arranged to compress the duckbill valve into an open position when the lever arrangement is actuated about a pivot axis.

21. A beverage dispensing module as claimed in claim 1 further comprising a beverage in the pouch.

22. A beverage dispensing module comprising:
a beverage reservoir;
a module outlet; and
a duckbill valve positioned between the beverage reservoir and the module outlet for selectively enabling fluid communication therebetween, the duckbill valve comprising first and second valve walls converging from first ends to second ends, the second ends being positioned closer to the reservoir than the first ends, and the second ends defining a valve mouth between valve tips,
wherein, in use, the reservoir contains a beverage and the beverage dispensing container further comprises a pressurising arrangement adapted, in use, to apply a pressure to the beverage such that the pressurised beverage in turn applies a pressure to the first and second valve walls and valve tips, and thereby maintains the valve mouth in a closed and sealed position.

23. A beverage dispensing module as claimed in claim 22 wherein the pressurising arrangement comprises a resilient bias means connected to a roller.

24. A beverage dispensing module as claimed in claim 22, further comprising a dispensing actuator to selectively apply a compressive force to the valve tips, so as to open the valve mouth.

25. A beverage dispensing module as claimed in claim 24 wherein the dispensing actuator comprises a lever arrangement connected to a dispensing lever, the lever arrangement being pivotable about a pivot axis upon actuation of the dispensing lever.

26. A beverage dispensing module as claimed in claim 25 wherein the lever arrangement comprises a valve arm for selectively applying the compressive force to the valve tips, so as to open the valve mouth.

27. A beverage dispensing module as claimed in claim 25 further comprising a container, the lever arrangement being located substantially within the container and the dispensing lever being located substantially outside of the container.

28. A beverage dispensing module as claimed in claim 22 wherein the duckbill valve is located within a resiliently deformable tube.

29. A beverage dispensing module as claimed in claim 25 wherein the dispensing actuator is arranged to provide a compressive force to an outer surface of the resilient deformable tube.

30. A flexible pouch for a beverage comprising:
a first major side panel connected to a first minor side panel along a first corner;
a second major side panel connected to the first minor side panel along a second corner; and
a first sealed region between the first major and minor side panels, wherein the first sealed region:
extends along and is located adjacent to the first corner; and
extends orthogonal to the first corner into the first major and minor side panels by a first width, said first width being greater in a central portion along the first corner than on either side of the central portion.

31. A flexible pouch as claimed in claim 30 further comprising a second sealed region between the second major side panel and the first minor side panel, wherein the second sealed region:
extends along and is located adjacent to the second corner; and
extends orthogonal to the second corner into the second major side panel and the first minor side panel by a second width, said second width being greater in a central portion along the second corner than on either side of the central portion.

32. A flexible pouch as claimed in claim 30 further comprising:
a second minor side panel connected to the first major side panel along a third corner and connected to the second major side panel along a fourth corner.

33. A flexible pouch as claimed in claim 32 further comprising:
a third sealed region between the first major side panel and second minor side panel, wherein the third sealed region:
extends along and is located adjacent to the third corner; and
extends orthogonal to the third corner into the first major side panel and second minor side panel by a third width, said third width being greater in a central portion along the third corner than on either side of the central portion; and
a fourth sealed region between second major and minor side panels, wherein the fourth sealed region:
extends along and is located adjacent to the fourth corner; and
extends orthogonal to the third corner into the second major and minor side panels by a fourth width, said fourth width being greater in a central portion along the fourth corner than on either side of the central portion.

34. A flexible pouch as claimed in claim 30 wherein the first, second, third and/or fourth width increases towards a first end of the first, second, third and/or fourth corner.

35. A flexible pouch as claimed in claim 34 wherein the first width increases towards the first end of the first corner by a greater magnitude than the increase in the second width towards the second end of the second corner.

36. A flexible pouch as claimed in claim 30 wherein:
a first minor edge of the first major side panel is attached to a first minor edge of the second major side panel; and
a second minor edge of the first major side panel is attached to a second minor edge of the second major side panel.

37. A flexible pouch as claimed in claim 36 further comprising:
a first end sealed region between, and adjacent to the first minor edges of, the first and second major side panels; and/or
a second end sealed region between, and adjacent to the second minor edges of, the first and second major side panels.

38. A flexible pouch as claimed in claim 37 wherein the first and/or second end sealed region(s) extends between the first, second, third and fourth sealed regions.

39. A flexible pouch as claimed in claim 38 further comprising an outlet arrangement having an aperture, said aperture being:
located between the second minor edges of the first and second major side panels; and
bounded by the second end sealed region and a third and a fourth end sealed regions, said third end sealed region being provided between the first major side panel and the second minor side panel adjacent to the third sealed region, and said fourth end sealed region being provided between the second major side panel and second minor side panel adjacent to the fourth sealed region.

40. A flexible pouch as claimed in claim 39 wherein the outlet arrangement further comprises protruding portions of the first and second major side panels.

41. A flexible pouch as claimed in claim 30 wherein the sealed region(s) are fin seals.

42. A flexible pouch as claimed in claim 30 wherein an internal gusset is attached to the inner faces of the first and second major side panels to restrain movement between the first and second major side panels to a predetermined displacement.

43. A flexible pouch for a beverage comprising:
a first major side panel connected to a first minor side panel along a first corner;
a second major side panel connected to the first minor side panel along a second corner; and
a first sealed region between the first major and minor side panels, wherein the first sealed region:
extends along and is located adjacent to the first corner;
extends orthogonal to the first corner into the first major and minor side panels by a first width; and
comprises a first portion extending from a first end of the first major and minor side panels towards a midpoint along the first corner, wherein the first width of the first portion decreases away from the first end.

44. A flexible pouch as claimed in claim 43 further comprising a second sealed region between the second major side panel and the first minor side panel, wherein the second sealed region:
extends along and is located adjacent to the second corner;
extends orthogonal to the second corner into the second major side panel and the first minor side panel by a second width; and
comprises a second portion extending from a first end of the second major side panel and the first minor side panel towards a midpoint along the second corner, wherein the second width of the second portion decreases away from the first end.

45. A flexible pouch as claimed in claim 44 wherein the second portion extends away from the first end by a greater magnitude than the first portion extends away from the first end.

46. A flexible pouch as claimed in claim 43 further comprising:
a second minor side panel connected to the first major side panel along a third corner and connected to the second major side panel along a fourth corner;
a third sealed region between the first major side panel and second minor side panel, wherein the third sealed region:
extends along and is located adjacent to the third corner; and
extends orthogonal to the third corner into the first major side panel and second minor side panel by a third width; and
comprises a third portion extending from a first end of the first major side panel and the second minor side panel towards a midpoint along the third corner,
wherein the third width of the third portion decreases away from the first end; and a fourth sealed region between second major and minor side panels, wherein the fourth sealed region:
extends along and is located adjacent to the fourth corner; and
extends orthogonal to the third corner into the second major and minor side panels by a fourth width; and
comprises a fourth portion extending from a first end of the second major and minor side panels towards a midpoint along the fourth corner, wherein the fourth width of the fourth portion decreases away from the first end.

47. A flexible pouch as claimed in claim 46 wherein the fourth portion extends away from the first end by a greater magnitude than the third portion extends away from the first end.

48. A flexible pouch as claimed in claim 43 wherein the decrease in first, second, third and/or fourth width of the first, second, third and/or fourth portion is at a constant rate.

49. A beverage dispensing module comprising the flexible pouch according to claim 30 and a beverage dispensing arrangement for selectively dispensing beverage from the flexible pouch.

50. A beverage dispensing module as claimed in of claim 1, further including a pouch comprising:
a first major side panel connected to a first minor side panel along a first corner;
a second major side panel connected to the first minor side panel along a second corner; and
a first sealed region between the first major and minor side panels, wherein the first sealed region:
extends along and is located adjacent to the first corner; and
extends orthogonal to the first corner into the first major and minor side panels by a first width, said first width being greater in a central portion along the first corner than on either side of the central portion.
